(19) United States
(12) Patent Application Publication
(10) Pub. No.: US 2021/0188638 A1
(43) Pub. Date: Jun. 24, 2021

(54) METHOD FOR PRODUCING A LITHIUM BIS(FLUOROSULFONYL)IMIDE SALT

(71) Applicant: Arkema France, Colombes (FR)

(72) Inventors: Philippe LEDUC, Pierre-Benite Cedex (FR); Grégory SCHMIDT, Pierre-Benite Cedex (FR); Dominique DEUR-BERT, Pierre-Benite Cedex (FR)

(73) Assignee: Arkema France, Colombes (FR)

(21) Appl. No.: 17/057,302

(22) PCT Filed: May 28, 2019
(86) PCT No.: PCT/FR2019/051238

§ 371 Date: Nov. 20, 2020

(30) Foreign Application Priority Data
Jun. 1, 2018 (FR) 1854764

(51) Int. Cl. C01B 21/086; B01J 19/02; B01J 19/00; H01M 10/0568; H01M 10/0525

(52) U.S. Cl. CPC C01B 21/086; B01J 19/02; B01J 19/0066; H01M 10/0568; B01J 2219/0286; B01J 2219/0277; B01J 2219/0259; B01J 2219/0245; H01M 10/0525

(57) ABSTRACT

A method for producing a lithium bis(fluorosulfonyl)imide salt F—(SO₂)—NLi—(SO₂)—F, comprising a step comprising a step of chlorination of sulfamic acid HO—(SO₂)—NH₂ in order to obtain the bis(chlorosulfonyl)imide Cl—(SO₂)—NH—(SO₂)—Cl, said step being carried out in a reactor made of a corrosion-resistant material M3, or in a reactor containing a base layer made of a material M1 coated with a surface layer made of a corrosion-resistant material M2.

### FIELD OF THE INVENTION

The present invention relates to a process for manufacturing a lithium bis(fluorosulfonyl)imide salt.

### TECHNICAL BACKGROUND

The development of higher-power batteries is required for the Li-ion battery market. This is done by increasing the nominal voltage of Li-ion batteries. To achieve the targeted voltages, high-purity electrolytes are required. By virtue of their very low basicity, anions of sulfonylimide type are increasingly used in the field of energy storage in the form of inorganic salts in batteries, or of organic salts in supercapacitors or in the field of ionic liquids.

In the specific field of Li-ion batteries, the salt that is currently the most widely used is LiPF₆. This salt has many drawbacks, such as limited thermal stability, sensitivity to hydrolysis and thus poorer safety of the battery. Recently, novel salts bearing the fluorosulfonyl group FSO₂- have been studied and have demonstrated many advantages such as better ion conductivity and resistance to hydrolysis. One of these salts, LiFSl has shown highly advantageous properties which make it a good candidate for replacing LiPF₆.

The identification and quantification of impurities in salts and/or electrolytes and the understanding of their impacts on battery performance have become paramount. For example, on account of their interference with electrochemical reactions, impurities bearing a labile proton lead to overall reduced performance qualities and stability for Li-ion batteries. The application of Li-ion batteries makes it necessary to have high-purity products (minimum amount of impurities).

The existing processes for preparing LiFSl notably comprise steps (for example chlorination, fluorination, etc.) involving corrosive reagents, and/or formation of corrosive byproducts, which give rise (under the operating conditions) to high corrosion of the material of the equipment used for the reactions. This corrosion induces contamination of said LiFSl with metal ions derived from said materials. Now, presence of metal ions in the LiFSl in excessive amount may disrupt the functioning and performance of the battery, for example on account of the deposition of said metal ions on the battery electrodes. Furthermore, corrosion of the materials of the equipment used compromises the structural integrity of the equipment and reduces its service life.

Thus, there is a need for a novel process for preparing a lithium salt of bis(fluorosulfonyl)imide leading to a high-purity LiFSl with a reduced content of metal ions.

### DESCRIPTION OF THE INVENTION

The present invention relates to a process for preparing a lithium salt of bis(fluorosulfonyl)imide F—(SO₂)—NLi—(SO₂)—F, comprising a step (a) comprising a step of chlorination of sulfamic acid HO—(SO₂)—NH₂ to obtain bis(chlorosulfonyl)imide Cl—(SO₂)—NH—(SO₂)—Cl, said step (a) being performed in a reactor made of a corrosion-resistant material M3, or in a reactor containing a base layer made of a material M1 coated with a surface layer made of a corrosion-resistant material M2.

In the context of the invention, the terms “lithium salt of bis(fluorosulfonyl)imide”, “LiFSl”, “LiN(FSO₂)₂”, “lithium bis(sulfonyl)imide”, or “lithium bis(fluorosulfonyl)imide” and “F—(SO₂)—NLi—(SO₂)—F” are used equivalently.

### Step (a)

The surface layer of the reactor of step (a) is the layer that is liable to be in contact with the reaction medium of the chlorination step (a) (for example starting reagents, products generated, etc.), the reaction medium possibly comprising any type of phase: liquid and/or gas and/or solid.

Preferably, the surface layer of the reactor of step (a) is at least in contact with at least one of the starting reagents, for instance sulfamic acid.

The base layer and the surface layer may be arranged one against the other by bonding. This is, for example, the case when the material M6 is a nickel-based alloy, as defined below. Preferably, the bonding is performed by weld bonding, explosive bonding, hot roll bonding or cold roll bonding, preferentially by explosive bonding.

According to one embodiment, the surface layer has a thickness of between 0.01 and 20 mm, said thickness of said inner surface layer being less than that of said base layer. Preferably, said inner surface layer has a thickness of between 0.05 and 15 mm, preferentially between 0.1 and 10 mm and advantageously between 0.1 and 5 mm.

Material M1

According to one embodiment, the material M1 comprises:
i) at least 60% by weight of iron, preferably at least 70% by weight, advantageously at least 75% by weight, even more advantageously at least 80% by weight, more preferentially at least 85% by weight, in particular at least 90% by weight, more particularly at least 95% by weight, and even more preferentially at least 97% by weight of iron relative to the total weight of the material M1; and
ii) less than 2% by weight of carbon, advantageously less than 1.5% by weight, preferably less than 1% by weight, more preferentially less than 0.75% by weight, in particular less than 0.5% by weight, more particularly less than 0.2% by weight, favorably less than 0.1% by weight of carbon relative to the total weight of the material M1; and/or
less than 3% by weight of molybdenum, advantageously less than 2% by weight, preferentially less than 1.5% by weight, preferably less than 1.25% by weight, more preferentially less than 1% by weight of molybdenum relative to the total weight of the material M1; and/or
less than 20% by weight of chromium, preferentially less than 5% by weight of chromium, advantageously less than 4% by weight, preferably less than 3% by weight, more preferentially less than 2% by weight, in particular less than 1% by weight of chromium relative to the total weight of the material M1; and/or
less than 15% by weight of nickel, preferentially 5% by weight, advantageously less than 4% by weight, preferably less than 3% by weight, more preferentially less than 2% by weight, in particular less than 1% by weight of nickel relative to the total weight of the material M1; and/or
less than 2% by weight of silicon, advantageously less than 1.5% by weight, preferably less than 1.25% by weight, more preferentially less than 1% by weight of silicon relative to the total weight of the material M1; and/or
less than 2.5% by weight of manganese, advantageously less than 2% by weight, preferably less than 1.5% by weight, more preferentially less than 1% by weight of manganese relative to the total weight of the material M1.

According to a preferred embodiment, the material M1 comprises:
i) at least 60% by weight of iron, preferably at least 70% by weight, advantageously at least 75% by weight, even more advantageously at least 80% by weight, more preferentially at least 85% by weight, in particular at least 90% by weight, more particularly at least 95% by weight, and even more preferentially at least 97% by weight of iron relative to the total weight of the material M1; and
ii) less than 2% by weight of carbon, advantageously less than 1.5% by weight, preferably less than 1% by weight, preferentially less than 0.75% by weight, more preferentially less than 0.5% by weight, more particularly less than 0.2% by weight, and even more advantageously between 0.01% and 0.2% by weight of carbon relative to the total weight of the material M1; and/or
less than 3% by weight of molybdenum, advantageously less than 2% by weight, preferentially less than 1.5% by weight, preferably less than 1.25% by weight, more preferentially less than 1% by weight, even more advantageously between 0.1% and 1% by weight of molybdenum relative to the total weight of the material M1; and/or
less than 5% by weight of chromium, preferentially less than 4% by weight, advantageously less than 3% by weight, preferably less than 2% by weight, in particular between 0.5% and 2% by weight of chromium relative to the total weight of the material M1; and/or
less than 2% by weight of silicon, advantageously less than 1.5% by weight, preferably between 0.1% and 1.5% by weight of silicon relative to the total weight of the material M1; and/or
less than 2.5% by weight of manganese, advantageously less than 2% by weight, preferably less than 1.5% by weight, more preferentially less than 1% by weight, in particular between 0.1% and 1% by weight of manganese relative to the total weight of the material M1.

Preferably, the material M1 comprises at least 60% by weight of iron, preferably at least 70% by weight of iron, advantageously at least 75% by weight, more even more advantageously at least 80% by weight, more preferentially at least 85% by weight, in particular at least 90% by weight, more particularly at least 95% by weight and even more preferentially at least 97% by weight of iron relative to the total weight of the material M1; and less than 2% by weight of carbon, advantageously less than 1.5% by weight, preferably less than 1% by weight, preferentially less than 0.75% by weight, more preferentially less than 0.5% by weight, more particularly less than 0.2% by weight, and even more advantageously between 0.01% and 0.2% by weight of carbon relative to the total weight of the material M1; and less than 3% by weight of molybdenum, advantageously less than 2% by weight, preferentially less than 1.5% by weight, preferably less than 1.25% by weight, more preferentially less than 1% by weight, even more advantageously between 0.1% and 1% by weight of molybdenum relative to the total weight of the material M1; and/or less than 5% by weight of chromium, preferentially less than 4% by weight, advantageously less than 3% by weight, preferably less than 2% by weight, in particular between 0.5% and 2% by weight of chromium relative to the total weight of the material M1.

According to another preferred embodiment, the material M1 comprises:
at least 60% by weight of iron, more particularly at least 70% by weight of iron, relative to the total weight of the material Ml;
less than 2% by weight of carbon, advantageously less than 1.5% by weight, preferably less than 1% by weight, more preferentially less than 0.75% by weight, in particular less than 0.5% by weight, more particularly less than 0.2% by weight, even more advantageously less than 0.1% by weight relative to the total weight of the material M1; and
from 10% to 20% by weight of chromium, advantageously from 15% to 20% by weight, in particular from 16% to 18.5% by weight of chromium relative to the total weight of the material M1;
and optionally:
less than 15% by weight of nickel, preferentially between 10% and 14% by weight of nickel, relative to the total weight of the material M1; and/or
less than 3% by weight of molybdenum, advantageously between 2% and 3.0% by weight of molybdenum, relative to the total weight of the material M1; and/or
less than 2.5% by weight of manganese, advantageously 2% by weight of manganese, relative to the total weight of the material M1; and/or
less than 2% by weight of silicon, advantageously less than 1.5% by weight, preferably less than 1.25% by weight, more preferentially less than 1% by weight of silicon relative to the total weight of the material M1.

Preferably, the material M1 comprises at least 60% by weight of iron, more particularly at least 70% by weight of iron relative to the total weight of the material M1; and less than 2% by weight of carbon, advantageously less than 1.5% by weight, preferably less than 1% by weight, more preferentially less than 0.75% by weight, in particular less than 0.5% by weight, more particularly less than 0.2% by weight, even more advantageously less than 0.1% by weight relative to the total weight of the material M1; and from 10% to 20% by weight of chromium, advantageously from 15% to 20% by weight, in particular from 16% to 18.5% by weight of chromium relative to the total weight of the material M1; and less than 15% by weight of nickel, preferentially between 10% and 14% by weight of nickel relative to the total weight of the material M1; and less than 3% by weight of molybdenum, advantageously between 2% and 3.0% by weight of molybdenum, relative to the total weight of the material M1; and less than 2.5% by weight of manganese, advantageously 2% by weight of manganese, relative to the total weight of the material M1; and less than 2% by weight of silicon, advantageously less than 1.5% by weight, preferably less than 1.25% by weight, more preferentially less than 1% by weight of silicon, relative to the total weight of the material M1.

Material M2

The material M2 may be chosen from the group consisting of enamel, fluoropolymers, and nickel-based alloys.

According to one embodiment, the material M2 is enamel. Typically, enamel mainly comprises SiO₂ in particular in a mass content of greater than 60% by mass, preferentially between 60% and 70% by mass. The enamel layer may be obtained by applying a suspension of glass powder in a sufficient thickness to the base layer of the inner wall of the reactor, followed by heating to ensure the melting of the glass powder, followed by cooling to allow an enamel layer to be obtained.

According to one embodiment, the material M2 is chosen from fluoropolymers, and in particular thermoplastic fluoropolymers. Examples that may be mentioned include PVDF (polyvinylidene fluoride), PTFE (polytetrafluoroethylene), PFAs (copolymers of C₂F₄ and of perfluorinated vinyl ether), FEPs (copolymers of tetrafluoroethylene and of perfluoropropene, for instance the copolymer of C₂F₄ and of C₃F₆), ETFE (copolymer of tetrafluoroethylene and of ethylene), and FKM (copolymer of hexafluoropropylene and of difluoroethylene).

According to one embodiment, the material M2 is chosen from nickel-based alloys, in particular from alloys comprising at least 40% by weight of nickel relative to the total weight of the material M2.

Advantageously, the material M2 is chosen from nickel-based alloys comprising at least 45% by weight of nickel, more preferentially at least 50% by weight of nickel, in particular at least 55% by weight of nickel, more particularly at least 60% by weight of nickel, favorably at least 65% by weight of nickel, even more favorably at least 70% by weight of nickel relative to the total weight of the material M2.

The material M2 may be chosen from nickel-based alloys comprising from 45% to 95% by weight of nickel, preferably from 50% to 90% by weight of nickel, relative to the total weight of the material M2.

The material M2 (nickel-based alloys) may also comprise chromium in a content of less than 35% by weight relative to the total weight of the material M2, advantageously less than 30% by weight, preferably less than 20% by weight, more preferentially less than 15% by weight, in particular less than 10% by weight, more particularly less than 5% by weight relative to the total weight of the material M2.

The material M2 (nickel-based alloys) may also comprise molybdenum in a content of less than 35% by weight relative to the total weight of the material M2, advantageously less than 30% by weight, preferably less than 20% by weight, more preferentially less than 15% by weight, in particular less than 10% by weight, more particularly less than 5% by weight relative to the total weight of the material M2.

Preferably, the material M2 (nickel-based alloys) comprises at least 40% by weight of nickel relative to the total weight of the material M2, preferably at least 45% by weight, more preferentially at least 50% by weight, in particular at least 55% by weight, more particularly at least 60% by weight, favorably at least 65% by weight, more favorably at least 70% by weight of nickel relative to the total weight of the material M2; and less than 35% by weight of chromium, advantageously less than 30% by weight, preferably less than 20% by weight, more preferentially less than 15% by weight, in particular less than 10% by weight, more particularly less than 5% by weight of chromium relative to the total weight of the material M2; and less than 35% by weight of molybdenum, advantageously less than 30% by weight, preferably less than 25% by weight, more preferentially less than 20% by weight, in particular less than 15% by weight, more particularly less than 10% by weight of molybdenum relative to the total weight of the material M2.

The material M2 (nickel-based alloys) may also comprise cobalt in a content of less than 10% by weight relative to the total weight of the material M2, advantageously less than 8% by weight, preferably less than 6% by weight, more preferentially less than 4% by weight, in particular less than 3% by weight, more particularly less than 2% by weight relative to the total weight of the material M2.

The material M2 (nickel-based alloys) may also comprise tungsten in a content of less than 5% by weight relative to the total weight of the material M2, advantageously less than 4% by weight, preferably less than 3% by weight, more preferentially less than 2% by weight, in particular less than 1% by weight relative to the total weight of the material M2.

The material M2 (nickel-based alloys) may also comprise iron in a content of less than 25% by weight relative to the total weight of the material M2, advantageously less than 20% by weight, preferably less than 15% by weight, more preferentially less than 10% by weight, in particular less than 7% by weight, more particularly less than 5% by weight relative to the total weight of the material M2.

The material M2 (nickel-based alloys) may also comprise manganese in a content of less than 5% by weight relative to the total weight of the alloy, advantageously less than 4% by weight, preferably less than 3% by weight, more preferentially less than 2% by weight, in particular less than 1% by weight, more particularly less than 0.5% by weight relative to the total weight of the material M2.

The material M2 (nickel-based alloys) may also comprise copper in a content of less than 50% by weight, advantageously less than 45% by weight, preferably less than 40% by weight, more preferentially less than 35% by weight, in particular less than 30% by weight, more particularly less than 25% by weight of copper relative to the total weight of the material M2.

Preferably, the material M2 (nickel-based alloys) comprises at least 40% by weight of nickel relative to the total weight of the material M2, preferably at least 45% by weight of nickel, more preferentially at least 50% by weight of nickel, in particular at least 55% by weight of nickel, more particularly at least 60% by weight of nickel, favorably at least 65% by weight of nickel, more favorably at least 70% by weight of nickel relative to the total weight of the material M2; and less than 50% by weight of copper, advantageously less than 45% by weight, preferably less than 40% by weight, more preferentially less than 35% by weight, in particular less than 30% by weight, more particularly less than 25% by weight of copper relative to the total weight of the material M2.

Preferably, the material M2 (nickel-based alloys) comprises at least 40% by weight of nickel relative to the total weight of the material M2, preferably at least 45% by weight of nickel, more preferentially at least 50% by weight of nickel, in particular at least 55% by weight of nickel, more particularly at least 60% by weight of nickel, favorably at least 65% by weight of nickel, more favorably at least 70% by weight of nickel relative to the total weight of the material M2; and less than 35% by weight of chromium, advantageously less than 30% by weight, preferably less than 20% by weight, more preferentially less than 15% by weight, in particular less than 10% by weight, more particularly less than 5% by weight of chromium relative to the total weight of the material M2; and less than 25% by weight of iron, advantageously less than 20% by weight, preferably less than 15% by weight, more preferentially less than 10% by weight, in particular less than 7% by weight, more particularly less than 5% by weight of iron relative to the total weight of the material M2; and optionally less than 35% by weight of molybdenum, advantageously less than 30% by weight, preferably less than 20% by weight, more preferentially less than 15% by weight, in particular less than 10% by weight, more particularly less than 5% by weight of molybdenum relative to the total weight of the material M2.

The material M2 (nickel-based alloys) may comprise less than 4% by weight of titanium relative to the total weight of the material M2, advantageously less than 3% by weight, preferably less than 2% by weight, more preferentially less than 1% by weight, in particular less than 0.5% by weight, more particularly less than 0.05% by weight of titanium relative to the total weight of the material M2; favorably, the material M2 is free of titanium.

The material M2 (nickel-based alloys) may comprise less than 6% by weight of niobium relative to the total weight of the material M2, advantageously less than 4% by weight, preferably less than 2% by weight, more preferentially less than 1% by weight, in particular less than 0.5% by weight, more particularly less than 0.05% by weight of niobium relative to the total weight of the material M2; favorably, the material M2 is free of niobium.

According to one embodiment, the reactor used in step (a) of the process according to the invention comprises a base layer made of a material M1 coated with a surface layer made of a corrosion-resistant material M2, said material M1 comprising:
at least 60% by weight of iron, preferably at least 70% by weight of iron, advantageously at least 75% by weight, more even more advantageously at least 80% by weight, more preferentially at least 85% by weight, in particular at least 90% by weight, more particularly at least 95% by weight and even more preferentially at least 97% by weight of iron relative to the total weight of the material M1; and less than 2% by weight of carbon, advantageously less than 1.5% by weight, preferably less than 1% by weight, preferentially less than 0.75% by weight, more preferentially less than 0.5% by weight, more particularly less than 0.2% by weight, and even more advantageously between 0.01% and 0.2% by weight of carbon relative to the total weight of the material M1; and less than 3% by weight of molybdenum, advantageously less than 2% by weight, preferentially less than 1.5% by weight, preferably less than 1.25% by weight, more preferentially less than 1% by weight, even more advantageously between 0.1% and 1% by weight of molybdenum relative to the total weight of the material M1; and/or less than 5% by weight of chromium, preferentially less than 4% by weight, advantageously less than 3% by weight, preferably less than 2% by weight, in particular between 0.5% and 2% by weight of chromium relative to the total weight of the material M1; and
the material M2 being chosen from nickel-based alloys, in particular chosen from alloys comprising at least 40% by weight of nickel, advantageously at least 45% by weight, more preferentially at least 50% by weight, in particular at least 55% by weight, more particularly at least 60% by weight, favorably at least 65% by weight, even more favorably at least 70% by weight of nickel relative to the total weight of the material M2; and/or chromium in a content of less than 35% by weight relative to the total weight of the material M2, advantageously less than 30% by weight, preferably less than 20% by weight, more preferentially less than 15% by weight, in particular less than 10% by weight, more particularly less than 5% by weight relative to the total weight of the material M2; and/or molybdenum in a content of less than 35% by weight relative to the total weight of the material M2, advantageously less than 30% by weight, preferably less than 25% by weight, more preferentially less than 20% by weight, in particular less than 15% by weight, more particularly less than 10% by weight relative to the total weight of the material M2; and/or cobalt in a content of less than 10% by weight relative to the total weight of the material M2, advantageously less than 8% by weight, preferably less than 6% by weight, more preferentially less than 4% by weight, in particular less than 3% by weight, more particularly less than 2% by weight relative to the total weight of the material M2; and/or tungsten in a content of less than 5% by weight relative to the total weight of the material M2, advantageously less than 4% by weight, preferably less than 3% by weight, more preferentially less than 2% by weight, in particular less than 1% by weight relative to the total weight of the material M2; and/or iron in a content of less than 25% by weight relative to the total weight of the material M2, advantageously less than 20% by weight, preferably less than 15% by weight, more preferentially less than 10% by weight, in particular less than 7% by weight, more particularly less than 5% by weight relative to the total weight of the material M2; and/or manganese in a content of less than 5% by weight relative to the total weight of the alloy, advantageously less than 4% by weight, preferably less than 3% by weight, more preferentially less than 2% by weight, in particular less than 1% by weight, more particularly less than 0.5% by weight relative to the total weight of the material M2; and/or copper in a content of less than 50% by weight, advantageously less than 45% by weight, preferably less than 40% by weight, more preferentially less than 35% by weight, in particular less than 30% by weight, more particularly less than 25% by weight of copper relative to the total weight of the material M2; and/or less than 4% by weight of titanium relative to the total weight of the material M2, advantageously less than 3% by weight, preferably less than 2% by weight, more preferentially less than 1% by weight, in particular less than 0.5% by weight, more particularly less than 0.05% by weight relative to the total weight of the material M2, the material M2 favorably being free of titanium; and/or less than 6% by weight of niobium, advantageously less than 4% by weight, preferably less than 2% by weight, more preferentially less than 1% by weight, in particular less than 0.5% by weight, more particularly less than 0.05% by weight of niobium relative to the total weight of the material M2, the material M2 favorably being free of niobium.

According to a preferred embodiment, the reactor used in step (a) of the process according to the invention comprises a base layer made of a material M1 coated with a surface layer made of a corrosion-resistant material M2, said material M1 comprising:
at least 60% by weight of iron, preferably at least 70% by weight of iron, advantageously at least 75% by weight, more even more advantageously at least 80% by weight, more preferentially at least 85% by weight, in particular at least 90% by weight, more particularly at least 95% by weight and even more preferentially at least 97% by weight of iron relative to the total weight of the material M1; and less than 2% by weight of carbon, advantageously less than 1.5% by weight, preferably less than 1% by weight, preferentially less than 0.75% by weight, more preferentially less than 0.5% by weight, more particularly less than 0.2% by weight, and even more advantageously between 0.01% and 0.2% by weight of carbon relative to the total weight of the material M1; and less than 3% by weight of molybdenum, advantageously less than 2% by weight, preferentially less than 1.5% by weight, preferably less than 1.25% by weight, more preferentially less than 1% by weight, even more advantageously between 0.1% and 1% by weight of molybdenum relative to the total weight of the material M1; and/or less than 5% by weight of chromium, preferentially less than 4% by weight, advantageously less than 3% by weight, preferably less than 2% by weight, in particular between 0.5% and 2% by weight of chromium relative to the total weight of the material M1; and
the material M2 being chosen from fluoropolymers, and in particular thermoplastic fluoropolymers, for instance PVDF (polyvinylidene fluoride), PTFE (polytetrafluoroethylene), PFAs (copolymers of C₂F₄ and of perfluorinated vinyl ether), FEPs (copolymers of tetrafluoroethylene and of perfluoropropene, for instance the copolymer of C₂F₄ and of C₃F₆), ETFE (copolymer of tetrafluoroethylene and of ethylene), and FKM (copolymer of hexafluoropropylene and of difluoroethylene).

According to another preferred embodiment, the reactor used in step (a) of the process according to the invention comprises a base layer made of a material M1 coated with a surface layer made of a corrosion-resistant material M2, said material M1 comprising:
at least 60% by weight of iron, preferably at least 70% by weight of iron, advantageously at least 75% by weight, more even more advantageously at least 80% by weight, more preferentially at least 85% by weight, in particular at least 90% by weight, more particularly at least 95% by weight and even more preferentially at least 97% by weight of iron relative to the total weight of the material M1; and less than 2% by weight of carbon, advantageously less than 1.5% by weight, preferably less than 1% by weight, preferentially less than 0.75% by weight, more preferentially less than 0.5% by weight, more particularly less than 0.2% by weight, and even more advantageously between 0.01% and 0.2% by weight of carbon relative to the total weight of the material M1; and less than 3% by weight of molybdenum, advantageously less than 2% by weight, preferentially less than 1.5% by weight, preferably less than 1.25% by weight, more preferentially less than 1% by weight, even more advantageously between 0.1% and 1% by weight of molybdenum relative to the total weight of the material M1; and/or less than 5% by weight of chromium, preferentially less than 4% by weight, advantageously less than 3% by weight, preferably less than 2% by weight, in particular between 0.5% and 2% by weight of chromium relative to the total weight of the material M1; and
the material M2 being enamel.

According to a preferred embodiment, the corrosion rate of the material M2 is less than 100 μm/year, preferably less than 90 μm/year, advantageously less than 80 μm/year, preferentially less than 70 μm/year, even more advantageously less than 60 μm/year and in particular less than 50 μm/year. This rate is measured according to the coupon method ASTM D 2 328-65 T.

Material M3

The reactor of step (a) may be made of a corrosion-resistant material M3.

In particular, the reactor is made of a corrosion-resistant bulk material M3.

Preferably, the material M3 is pure nickel.

In the context of the invention, the term “the material M3 is pure nickel” means a material M3 comprising at least 99% by weight of nickel, preferably at least 99.1%, preferentially at least 99.2%, advantageously at least 99.3%, even more advantageously at least 99.4%, for example at least 99.5%, and in particular at least 99.6%, relative to the total weight of said material M3. When the material M3 is pure nickel, it may also comprise:
iron in a content of less than 1% by weight relative to the total weight of the material M3, advantageously less than 0.9% by weight, preferably less than 0.8% by weight, more preferentially less than 0.7% by weight, in particular less than 0.6% by weight, more particularly less than 0.5% by weight relative to the total weight of the material M3. Preferably, the material M3 comprises between 0.1% and 1% by weight of iron, in particular between 0.3% and 0.8% by weight of iron, more particularly between 0.3% and 0.5% by weight of iron relative to the total weight of the material M3; and/or
manganese in a content of less than 1% by weight relative to the total weight of the material M3, advantageously less than 0.9% by weight, preferably less than 0.8% by weight, more preferentially less than 0.7% by weight, in particular less than 0.6% by weight, more particularly less than 0.5%, favorably less than 0.4% by weight, relative to the total weight of the material M3; and/or
silicon in a content of less than 1% by weight relative to the total weight of the material M3, advantageously less than 0.9% by weight, preferably less than 0.8% by weight, more preferentially less than 0.7% by weight, in particular less than 0.6% by weight, more particularly less than 0.5% by weight relative to the total weight of the material M3; and/or
copper in a content of less than 1% by weight relative to the total weight of the material M3, advantageously less than 0.9% by weight, preferably less than 0.8% by weight, more preferentially less than 0.7% by weight, in particular less than 0.6% by weight, more particularly less than 0.5%, favorably less than 0.4% by weight, particularly favorably less than 0.3% relative to the total weight of the material M3; and/or
carbon in a content of less than 0.1% by weight relative to the total weight of the material M3, advantageously less than 0.09% by weight, preferably less than 0.08% by weight, more preferentially less than 0.07% by weight, in particular less than 0.06% by weight, more particularly less than 0.05% by weight, favorably less than 0.04% by weight, particularly favorably less than 0.03% by weight relative to the total weight of the material M3.

By way of example, mention may be made of Ni201 comprising at least 99% by weight of nickel, not more than 0.02% by weight of carbon, not more than 0.40% by weight of iron, not more than 0.35% by weight of manganese, not more than 0.35% by weight of silicon and not more than 0.25% of copper; or Ni200 comprising at least 99% by weight of nickel, not more than 0.15% by weight of carbon, not more than 0.40% by weight of iron, not more than 0.35% by weight of manganese, not more than 0.35% by weight of silicon and not more than 0.25% of copper.

According to a preferred embodiment, the corrosion rate of the material M3 is less than 100 μm/year, preferably less than 90 μm/year, advantageously less than 80 μm/year, preferentially less than 70 μm/year, even more advantageously less than 60 μm/year and in particular less than 50 μm/year. This rate is measured according to the coupon method ASTM D 2 328-65 T.

Reactor

Preferably, the reactor is fed with starting reagents via feed lines. The reactor may also comprise effluent or outlet lines for removing the reaction medium from the reactor.

Preferably, the feed or outlet lines of the reactor are made of a specific material that is also capable of withstanding corrosion, for example made of the abovementioned material M3. The feed lines may be of tubular shape. Alternatively, the feed or outlet lines may be made of a material comprising a base layer made of an abovementioned material M1 coated with a surface layer, which is liable to be in contact with the reaction medium, made of an abovementioned material M2.

According to one embodiment, the reactor of step (a) is a stirred reactor equipped with stirring head(s).

Among the stirring heads, examples that may be mentioned include turbomixers (for example Rushton straight-blade turbomixers or curved-blade turbomixers), helical strips, impellers (for example profiled-blade impellers), anchors, and combinations thereof.

The stirring head(s) may be attached to a central stirring shaft, and may be of identical or different nature. The stirring shaft may be driven by a motor, which is advantageously outside the reactor.

The design and size of the stirring heads may be chosen by a person skilled in the art as a function of the type of mixing to be performed (mixing of liquids, mixing of liquid and solid, mixing of liquid and gas, mixing of liquid, gas and solid) and of the desired mixing performance. In particular, the stirring head is chosen from the stirring heads that are the best suited for ensuring good homogeneity of the reaction medium. In the particular case of the presence of a medium which is at least a solid/liquid two-phase medium, or even a solid/liquid/gas three-phase medium, under the reaction conditions used in step (a), the stirring head is advantageously chosen from the stirring heads that are the best suited for ensuring good homogeneity of the reaction medium, and good suspension of the solid in the liquid phase.

Preferably, the stirring head(s) are made of a corrosion-resistant material, for instance made of the material M3 as defined above, or may comprise a base layer made of an abovementioned material M1 coated with a surface layer, which is liable to be in contact with the reaction medium, made of an abovementioned corrosion-resistant material M2.

The reactor of step (a) may comprise heating means.

The reactor of step (a) may be heated by means of a jacket surrounding the reactor, in which a heating fluid may circulate, for example steam or hot water.

According to one embodiment, step (a) is performed in a reactor having a global thermal conductivity of greater than or equal to 10 W/m/° C., preferably greater than or equal to 15 W/m/° C.

When the reactor contains a base layer made of a material M1 coated with a surface layer made of a corrosion-resistant material M2, the global thermal conductivity λ_{1,2} of the reactor composed of M1 and M2 is calculated according to the following formula:

λ_{1,2}=(e₁+e₂)/((e₁/λ₁)+(e₂/λ₂))

with a thickness e₁ representing the thickness of the material M1, e₂ representing the thickness of the material M2, λ₁ representing the thermal conductivity of the material M1 and λ_{1,2} representing the thermal conductivity of the material M2.

When the reactor is made of a material M3, the global thermal conductivity is that of the material M3.

Reaction Conditions

According to one embodiment, the chlorination step (a) is performed using sulfamic acid, with at least one sulfur-based acid and at least one chlorinating agent.

Step (a) may be performed:
at a temperature of between 30° C. and 150° C., preferably between 30° C. and 120° C., and advantageously between 30° C. and 100° C.; and/or
with a reaction time of between 1 hour and 7 days, preferably between 1 hour and 5 days and advantageously between 1 hour and 3 days; and/or
at a pressure of between 1 bar abs and 7 bar abs, preferably between 1 bar abs and 5 bar abs, and advantageously between 1 bar abs and 3 bar abs.

According to the invention, the sulfur-based agent may be chosen from the group consisting of chlorosulfonic acid (CISO₃H), sulfuric acid, oleum and mixtures thereof. Preferably, the sulfur-based agent is sulfuric acid.

According to the invention, the chlorinating agent may be chosen from the group consisting of thionyl chloride (SOCl₂), oxalyl chloride (COCl)₂, phosphorus pentachloride (PCl₅), phosphonyl trichloride (PCl₃), phosphoryl trichloride (POCl₃) and mixtures thereof. Preferably, the chlorinating agent is thionyl chloride.

The chlorination step (a) may be performed in the presence of a catalyst chosen, for instance, from a tertiary amine (such as methylamine, triethylamine or diethylmethylamine); pyridine; and 2,6-lutidine.

The mole ratio between the sulfur-based acid and the sulfamic acid may be between 0.7 and 5, preferably between 1 and 5.

The mole ratio between the chlorinating agent and the acid may be between 3 and 10, preferably between 2 and 5.

In particular, when the sulfur-based agent is chlorosulfonic acid, the mole ratio between the latter and the sulfamic acid is between 1 and 5 and/or the mole ratio between the chlorinating agent and the sulfamic acid is between 2 and 5.

In particular, when the sulfur-based agent is sulfuric acid (or oleum), the mole ratio between the sulfuric acid (or oleum) and the sulfamic acid is between 0.7 and 5.

In particular, when the sulfur-based agent is sulfuric acid (or oleum), the mole ratio between the sulfuric acid (or oleum) and the sulfamic acid is between 1 and 5 and/or the mole ratio between the chlorinating agent and the sulfamic acid is between 3 and 10.

The abovementioned sulfur-based agents and chlorinating agents are in particular corrosive. The same is also true for certain products formed, for instance bis(chlorosulfonyl)imide Cl—(SO₂)—NH—(SO₂)—Cl and HCl.

The use of the reactor as defined above advantageously makes it possible to withstand the corrosiveness of the reaction medium (starting reagents and/or products formed) under the reaction conditions, and thus to avoid contamination of the medium with metal ions.

### Step (b)

The process according to the invention may also comprise a step (b), subsequent to step (a), comprising the reaction of bis(chlorosulfonyl)imide CI-(S02)—NH—(S02)-CI with a fluorinating agent, to form bis(fluorosulfonate)imide F-(S02)—NH—(S02)-F.

Reaction Conditions

The fluorinating agent may be chosen from the group consisting of HF (preferably anhydrous HF), KF, AsF₃, BiF₃, ZnF₂, SnF₂, PbF₂, CuF₂, and mixtures thereof, the fluorinating agent preferably being HF, and even more preferentially anhydrous HF.

In the context of the invention, the term “anhydrous HF” means HF containing less than 500 ppm of water, preferably less than 300 ppm of water, preferably less than 200 ppm of water.

Step (b) of the process is preferably performed in at least one organic solvent OS1. The organic solvent OS1 preferably has a donor number of between 1 and 70 and advantageously between 5 and 65. The donor number of a solvent represents the value −ΔH, AH being the enthalpy of the interaction between the solvent and antimony pentachloride (according to the method described in Journal of Solution Chemistry, vol. 13, No. 9, 1984). As organic solvent OS1, mention may notably be made of esters, nitriles, dinitriles, ethers, diethers, amines, phosphines, and mixtures thereof.

Preferably, the organic solvent OS1 is chosen from the group consisting of methyl acetate, ethyl acetate, butyl acetate, acetonitrile, propionitrile, isobutyronitrile, glutaronitrile, dioxane, tetrahydrofuran, triethylamine, tripropylamine, diethylisopropylamine, pyridine, trimethylphosphine, triethylphosphine, diethylisopropylphosphine, and mixtures thereof. In particular, the organic solvent OS1 is dioxane.

Step (b) may be performed at a temperature of between 0° C. and the boiling point of the organic solvent OS1 (or of the organic solvent mixture OS1). Preferably, step (b) is performed at a temperature of between 5° C. and the boiling point of the organic solvent OS1 (or of the organic solvent mixture OS1), preferentially between 25° C. and the boiling point of the organic solvent OS1 (or of the organic solvent mixture OS1).

Step (b), preferably with anhydrous hydrofluoric acid, may be performed at a pressure P, preferably between 0 and 16 bar abs.

This step (b) is preferably performed by dissolving the bis(chlorosulfonyl)imide Cl—(SO₂)—NH—(SO₂)—Cl in the organic solvent OS1, or the organic solvent mixture OS1, prior to the step of reaction with the fluorinating agent, preferably with anhydrous HF.

The mass ratio between the bis(chlorosulfonyl)imide Cl—(SO₂)—NH—(SO₂)—Cl and the organic solvent OS1, or the organic solvent mixture OS1, is preferably between 0.001 and 10, and advantageously between 0.005 and 5.

According to one embodiment, anhydrous HF is introduced into the reaction medium in liquid form or in gaseous form, preferably in gaseous form.

The mole ratio x between the fluorinating agent, preferably anhydrous HF, and the bis(chlorosulfonyl)imide Cl—(SO₂)—NH—(SO₂)—Cl used is preferably between 2 and 10, and advantageously between 2 and 5.

The step of reaction with the fluorinating agent, preferably anhydrous HF, may be performed in a closed medium or in an open medium; preferably, step (b) is performed in an open medium notably with evolution of HCl in gaseous form.

Materials M4, M5, M6

According to a preferred embodiment, step (b) is performed in a reactor made of a corrosion-resistant material M4, or in a reactor containing a base layer made of a material M5 coated with a surface layer made of a corrosion-resistant material M6.

The surface layer of the reactor of step (b) is the layer that is liable to be in contact with the reaction medium of the fluorination step (b) (for example starting reagents, products generated, etc.), the reaction medium possibly comprising any type of phase: liquid and/or gas and/or solid.

Preferably, the surface layer of the reactor of step (b) is at least in contact with at least one of the starting reagents, for example the bis(chlorosulfonyl)imide.

The base layer and the surface layer may be arranged one against the other by bonding. This is, for example, the case when the material M2 is a nickel-based alloy, as defined below. Preferably, the bonding is performed by weld bonding, explosive bonding, hot roll bonding or cold roll bonding, preferentially by explosive bonding.

According to one embodiment, the surface layer has a thickness of between 0.01 and 20 mm, said thickness of said inner surface layer being less than that of said base layer. Preferably, said inner surface layer has a thickness of between 0.05 and 15 mm, preferentially between 0.1 and 10 mm and advantageously between 0.1 and 5 mm.

In particular, the reactor is made of a corrosion-resistant bulk material M4.

The material M4 may be chosen from the material M3 as defined above, or a material M4 comprising:
at least 60% by weight of iron, more particularly at least 70% by weight of iron, relative to the total weight of the material M4;
less than 2% by weight of carbon, advantageously less than 1.5% by weight, preferably less than 1% by weight, more preferentially less than 0.75% by weight, in particular less than 0.5% by weight, more particularly less than 0.2% by weight, even more advantageously less than 0.1% by weight relative to the total weight of the material M4; and
from 10% to 20% by weight of chromium, advantageously from 15% to 20% by weight, in particular from 16% to 18.5% by weight of chromium relative to the total weight of the material M4;
and optionally:
less than 15% by weight of nickel, preferentially between 10% and 14% by weight of nickel, relative to the total weight of the material M4; and/or
less than 3% by weight of molybdenum, advantageously between 2% and 3% by weight of molybdenum, relative to the total weight of the material M4; and/or
less than 2.5% by weight of manganese, advantageously 2% by weight of manganese, relative to the total weight of the material M4; and/or
less than 2% by weight of silicon, advantageously less than 1.5% by weight, preferably less than 1.25% by weight, more preferentially less than 1% by weight of silicon relative to the total weight of the material M4.

Preferably, the material M4 comprises at least 60% by weight of iron, more particularly at least 70% by weight of iron relative to the total weight of the material M4; and less than 2% by weight of carbon, advantageously less than 1.5% by weight, preferably less than 1% by weight, more preferentially less than 0.75% by weight, in particular less than 0.5% by weight, more particularly less than 0.2% by weight, even more advantageously less than 0.1% by weight relative to the total weight of the material M4; and from 10% to 20% by weight of chromium, advantageously from 15% to 20% by weight, in particular from 16% to 18.5% by weight of chromium relative to the total weight of the material M4; and less than 15% by weight of nickel, preferentially between 10% and 14% by weight of nickel relative to the total weight of the material M4; and less than 3% by weight of molybdenum, advantageously between 2% and 3% by weight of molybdenum, relative to the total weight of the material M4; and less than 2.5% by weight of manganese, advantageously 2% by weight of manganese, relative to the total weight of the material M4; and less than 2% by weight of silicon, advantageously less than 1.5% by weight, preferably less than 1.25% by weight, more preferentially less than 1% by weight of silicon, relative to the total weight of the material M4.

Preferably, the material M5 is the material M1 as defined above. More preferentially, the material M5 comprises at least 60% by weight of iron, preferably at least 70% by weight of iron, advantageously at least 75% by weight, more even more advantageously at least 80% by weight, more preferentially at least 85% by weight, in particular at least 90% by weight, more particularly at least 95% by weight and even more preferentially at least 97% by weight of iron relative to the total weight of the material M5; and less than 2% by weight of carbon, advantageously less than 1.5% by weight, preferably less than 1% by weight, preferentially less than 0.75% by weight, more preferentially less than 0.5% by weight, more particularly less than 0.2% by weight, and even more advantageously between 0.01% and 0.2% by weight of carbon relative to the total weight of the material M5; and less than 3% by weight of molybdenum, advantageously less than 2% by weight, preferentially less than 1.5% by weight, preferably less than 1.25% by weight, more preferentially less than 1% by weight, even more advantageously between 0.1% and 1% by weight of molybdenum relative to the total weight of the material M5; and/or less than 5% by weight of chromium, preferentially less than 4% by weight, advantageously less than 3% by weight, preferably less than 2% by weight, in particular between 0.5% and 2% by weight of chromium relative to the total weight of the material M5.

The material M6 may be chosen from the group consisting of enamel, polymers (in particular fluoropolymers), and nickel-based alloys (the nickel-based alloys being in particular those defined above for the material M2).

Preferably, the material M6 is chosen from polymers, in particular polyolefins (for instance polyethylene), and fluoropolymers, for instance PVDF (polyvinylidene fluoride), PTFE (polytetrafluoroethylene), PFAs (copolymers of C₂F₄ and of perfluorinated vinyl ether), FEPs (copolymers of tetrafluoroethylene and of perfluoropropene, for instance the copolymer of C₂F₄ and of C₃F₆), ETFE (copolymer of tetrafluoroethylene and of ethylene), and FKM (copolymer of hexafluoropropylene and of difluoroethylene); more preferentially, the material M6 is chosen from PTFEs and PFAs.

According to one preferred embodiment, the reactor used in step (b) of the process according to the invention comprises a base layer made of a material M5 coated with a surface layer made of a corrosion-resistant material M6, said material M5 comprising:
at least 60% by weight of iron, preferably at least 70% by weight of iron, advantageously at least 75% by weight, more even more advantageously at least 80% by weight, more preferentially at least 85% by weight, in particular at least 90% by weight, more particularly at least 95% by weight and even more preferentially at least 97% by weight of iron relative to the total weight of the material M5; and less than 2% by weight of carbon, advantageously less than 1.5% by weight, preferably less than 1% by weight, preferentially less than 0.75% by weight, more preferentially less than 0.5% by weight, more particularly less than 0.2% by weight, and even more advantageously between 0.01% and 0.2% by weight of carbon relative to the total weight of the material M5; and less than 3% by weight of molybdenum, advantageously less than 2% by weight, preferentially less than 1.5% by weight, preferably less than 1.25% by weight, more preferentially less than 1% by weight, even more advantageously between 0.1% and 1% by weight of molybdenum relative to the total weight of the material M5; and/or less than 5% by weight of chromium, preferentially less than 4% by weight, advantageously less than 3% by weight, preferably less than 2% by weight, in particular between 0.5% and 2% by weight of chromium relative to the total weight of the material M5; and
the material M6 being chosen from fluoropolymers, and in particular thermoplastic fluoropolymers, for instance PVDF (polyvinylidene fluoride), PTFE (polytetrafluoroethylene), PFAs (copolymers of C₂F₄ and of perfluorinated vinyl ether), FEPs (copolymers of tetrafluoroethylene and of perfluoropropene, for instance the copolymer of C₂F₄ and of C₃F₆), ETFE (copolymer of tetrafluoroethylene and of ethylene), and FKM (copolymer of hexafluoropropylene and of difluoroethylene), more preferentially the material M6 being chosen from PTFEs and PFAs.

According to another preferred embodiment, the reactor used in step (b) of the process according to the invention is made of a corrosion-resistant material M4, said material M4 comprising at least 60% by weight of iron, more particularly at least 70% by weight of iron relative to the total weight of the material M4; and less than 2% by weight of carbon, advantageously less than 1.5% by weight, preferably less than 1% by weight, more preferentially less than 0.75% by weight, in particular less than 0.5% by weight, more particularly less than 0.2% by weight, even more advantageously less than 0.1% by weight relative to the total weight of the material M4; and from 10% to 20% by weight of chromium, advantageously from 15% to 20% by weight, in particular from 16% to 18.5% by weight of chromium relative to the total weight of the material M4; and less than 15% by weight of nickel, preferentially between 10% and 14% by weight of nickel relative to the total weight of the material M4; and less than 3% by weight of molybdenum, advantageously between 2% and 3% by weight of molybdenum relative to the total weight of the material M4; and less than 2.5% by weight of manganese, advantageously 2% by weight of manganese relative to the total weight of the material M4; and less than 2% by weight of silicon, advantageously less than 1.5% by weight, preferably less than 1.25% by weight, more preferentially less than 1% by weight of silicon relative to the total weight of the material M4.

According to a preferred embodiment, the corrosion rate of the material M4 is less than 100 μm/year, preferably less than 90 μm/year, advantageously less than 80 μm/year, preferentially less than 70 μm/year, even more advantageously less than 60 μm/year and in particular less than 50 μm/year. This rate is measured according to the coupon method ASTM D 2 328-65 T.

According to a preferred embodiment, the corrosion rate of the material M6 is less than 100 μm/year, preferably less than 90 μm/year, advantageously less than 80 μm/year, preferentially less than 70 μm/year, even more advantageously less than 60 μm/year and in particular less than 50 μm/year. This rate is measured according to the coupon method ASTM D 2 328-65 T.

Reactor

Preferably, the reactor is fed with starting reagents via feed lines. The reactor may also comprise effluent or outlet lines for removing the reaction medium from the reactor.

Preferably, the feed or outlet lines of the reactor are made of a specific material that is also capable of withstanding corrosion, for example made of the abovementioned material M4. The feed lines may be of tubular shape. Alternatively, the feed or outlet lines may be made of a material comprising a base layer made of an abovementioned material M5 coated with a surface layer, which is liable to be in contact with the reaction medium, made of a corrosion-resistant material M6.

According to one embodiment, the reactor of step (b) is a stirred reactor equipped with stirring head(s).

Among the stirring heads, examples that may be mentioned include turbomixers (for example Rushton straight-blade turbomixers or curved-blade turbomixers), helical strips, impellers (for example profiled-blade impellers), anchors, and combinations thereof.

The stirring head(s) may be attached to a stirring shaft, and may be of identical or different nature. The stirring shaft may be driven by a motor, which is advantageously outside the reactor.

The design and size of the stirring head(s) may be chosen by a person skilled in the art as a function of the type of mixing to be performed (mixing of liquids, mixing of liquid and solid, mixing of liquid and gas, mixing of liquid, gas and solid) and of the desired mixing performance. In particular, the stirring head is chosen from the stirring heads that are the best suited for ensuring good homogeneity of the reaction medium.

Preferably, the stirring head(s) are made of a corrosion-resistant material, for instance made of the material M4 as defined above, or may comprise a base layer made of an abovementioned material M5 coated with a surface layer, which is liable to be in contact with the reaction medium, made of an abovementioned corrosion-resistant material M6.

The reactor of step (b) may comprise heating means.

The reactor of step (b) may be heated by means of a jacket surrounding the reactor, in which a heating fluid may circulate, for example steam or hot water.

According to one embodiment, step (b) is performed in a reactor having a global thermal conductivity of greater than or equal to 10 W/m/° C., preferably greater than or equal to 15 W/m/° C.

When the reactor contains a base layer made of a material M5 coated with a surface layer made of a corrosion-resistant material M6, the global thermal conductivity λ_{5,6} of the reactor composed of M5 and M6 is calculated according to the following formula:

λ_{5,6}=(e₅+e₆)/((e₅/λ₆)+(e₆/λ₆))

with a thickness es representing the thickness of the material M5, es representing the thickness of the material M6, λ₅ representing the thermal conductivity of the material M5 and λ6 representing the thermal conductivity of the material M6.

When the reactor is made of a material M4, the global thermal conductivity is that of the material M4.

The fluorination reaction typically leads to the formation of HCl, the majority of which may be degassed from the reaction medium (just like the excess HF if the fluorinating agent is HF), for example by stripping with a neutral gas (such as nitrogen, helium or argon).

However, the residual HF and/or HCl may be dissolved in the reaction medium. In the case of HCl, the amounts are very low since, at the working pressure and temperature, HCl is mainly in gas form.

The abovementioned anhydrous HF and HCl are in particular corrosive. The same is also true for the bis(chlorosulfonyl)imide Cl—(SO₂)—NH—(SO₂)—Cl. The use of the reactor as defined above advantageously makes it possible to withstand the corrosiveness of the reaction medium (starting reagents and/or products formed) under the reaction conditions, and thus to avoid contamination of the medium with metal ions originating from the materials of the reactor.

### Step (c)

The process according to the invention may also comprise a step (c), subsequent to step (b), comprising the preparation of an alkali metal or alkaline-earth metal salt of bis(fluorosulfonyl)imide by neutralization of bis(fluorosulfonyl)imide.

Reaction Conditions

Step (c) of the process according to the invention may be performed by placing the bis(fluorosulfonyl)imide in contact with an aqueous solution of a base chosen from alkali metal or alkaline-earth metal carbonates of formula MCO₃.nH₂O or alkali metal or alkaline-earth metal hydroxides MOH.nH₂O with M representing a monovalent alkali metal or alkaline-earth metal cation and n possibly ranging from 0 to 10. Preferably, MOH represents LiOH, NaOH, KOH, RbOH or CsOH. Preferably, MCO₃ represents Na₂CO₃, K₂CO₃, Rb₂CO₃, Cs₂CO₃ or Li₂CO₃, MCO₃ advantageously representing Na₂CO₃, K₂CO₃, Rb₂CO₃ or Cs₂CO₃.

Preferably, M does not represent Li⁺.

Preferably, the base used is not a base comprising lithium. Preferably, the base used comprises potassium.

Step (c) advantageously allows the preparation of a compound of formula (I) below:

F—(SO₂)—NM—(SO₂)—F (I)

in which M is as defined above, M preferably being other than Li⁺.

Step (c) may be performed, for example, by adding an aqueous solution of the chosen base. The base/bis(fluorosulfonyl)imide F—(SO₂)—NH—(SO₂)-F mole ratio may be, for example, from 1 to 5 when the base is a hydroxide, or from 0.5 to 5 (or from 2 to 10) when the base is a carbonate.

The reaction temperature of step (c) may be, for example, between −10° C. and 40° C.

The solution obtained on conclusion of step (c) comprising the alkali metal or alkaline-earth metal salt of bis(fluorosulfonyl)imide, preferably of formula (I), may then be filtered, giving a filtrate F and a cake G.

Depending on the nature of the alkali metal or alkaline-earth metal, the desired salt may be present in the filtrate F and/or in the cake G. The alkali metal or alkaline-earth metal fluorides are notably present in the cake G, but may also be found in the filtrate F.

The filtrate F may be subjected to at least one step of extraction with an organic solvent OS2 that is typically sparingly soluble in water, in order to extract the desired salt, preferably of the abovementioned formula (I), in an organic phase. The extraction step typically results in the separation of an aqueous phase and an organic phase.

The abovementioned organic solvent OS2 is in particular chosen from the following families: esters, nitriles, ethers, chlorinated solvents and aromatic solvents, and mixtures thereof. Preferably, the organic solvent OS2 is chosen from dichloromethane, ethyl acetate, butyl acetate, tetrahydrofuran, acetonitrile and diethyl ether, and mixtures thereof. In particular, the organic solvent OS2 is butyl acetate.

For each extraction, the mass amount of organic solvent used may range between 1/6 and 1 times the mass of the filtrate F. The number of extractions may be between 2 and 10.

Preferably, the organic phase, resulting from the extraction(s), has a mass content of desired salt, preferably of formula (I), ranging from 5% to 50% by mass.

The separated organic phase (obtained on conclusion of the extraction) may then be concentrated to reach a concentration of desired salt, preferably of formula (I), of between 5% and 55%, preferably between 10% and 50% by mass, said concentration possibly being achieved by any evaporation means known to those skilled in the art.

The abovementioned cake G may be washed with an organic solvent OS3 chosen from the following families: esters, nitriles, ethers, chlorinated solvents and aromatic solvents, and mixtures thereof. Preferably, the organic solvent OS3 is chosen from dichloromethane, ethyl acetate, butyl acetate, tetrahydrofuran, acetonitrile and diethyl ether, and mixtures thereof. In particular, the organic solvent OS3 is butyl acetate.

The mass amount of organic solvent OS3 used may range between 1 and 10 times the weight of the cake. The total amount of organic solvent OS3 intended for the washing may be used in a single portion or in several portions for the purpose notably of optimizing the dissolution of the desired salt, preferably of the abovementioned formula (I).

Preferably, the organic phase, resulting from the washing(s) of the cake G, has a mass content of desired salt, preferably of formula (I), ranging from 5% to 50% by mass.

The separated organic phase resulting from the washing of the cake G may then be concentrated to reach a concentration of desired salt, preferably of formula (I), of between 5% and 55%, preferably between 10% and 50% by mass, it being possible for said concentration to be achieved by any evaporation means known to those skilled in the art.

According to one embodiment, the organic phases resulting from the extraction of the filtrate F and from the washing of the cake G may be pooled, before the optional concentration step.

Materials M7, M8 and M9

According to a preferred embodiment, step (c) is performed in a reactor made of a corrosion-resistant material M7, or in a reactor containing a base layer made of a material M8 coated with a surface layer made of a corrosion-resistant material M9.

The surface layer of the reactor of step (c) is the layer that is liable to be in contact with the reaction medium of the neutralization step (c) (for example starting reagents, products generated, etc.), the reaction medium possibly comprising any type of phase: liquid and/or gas and/or solid.

Preferably, the surface layer of the reactor of step (c) is at least in contact with at least one of the starting reagents, for example the bis(fluorosulfonyl)imide.

The base layer and the surface layer may be arranged one against the other by bonding. This is, for example, the case when the material M9 is a nickel-based alloy, as defined below. Preferably, the bonding is performed by weld bonding, explosive bonding, hot roll bonding or cold roll bonding, preferentially by explosive bonding.

According to one embodiment, the surface layer has a thickness of between 0.01 and 20 mm, said thickness of said inner surface layer being less than that of said base layer. Preferably, said inner surface layer has a thickness of between 0.05 and 15 mm, preferentially between 0.1 and 10 mm and advantageously between 0.1 and 5 mm.

Preferably, the material M7 is the material M4 as defined above. More preferentially, the material M7 comprises at least 60% by weight of iron, more particularly at least 70% by weight of iron relative to the total weight of the material M7; and less than 2% by weight of carbon, advantageously less than 1.5% by weight, preferably less than 1% by weight, more preferentially less than 0.75% by weight, in particular less than 0.5% by weight, more particularly less than 0.2% by weight, even more advantageously less than 0.1% by weight relative to the total weight of the material M7; and from 10% to 20% by weight of chromium, advantageously from 15% to 20% by weight, in particular from 16% to 18.5% by weight of chromium relative to the total weight of the material M7; and less than 15% by weight of nickel, preferentially between 10% and 14% by weight of nickel relative to the total weight of the material M7; and less than 3% by weight of molybdenum, advantageously between 2% and 3% by weight of molybdenum, relative to the total weight of the material M7; and less than 2.5% by weight of manganese, advantageously 2% by weight of manganese, relative to the total weight of the material M7; and less than 2% by weight of silicon, advantageously less than 1.5% by weight, preferably less than 1.25% by weight, more preferentially less than 1% by weight of silicon, relative to the total weight of the material M7.

Preferably, the material M8 is the material M1 as defined above. More preferentially, the material M8 comprises at least 60% by weight of iron, preferably at least 70% by weight of iron, advantageously at least 75% by weight, more even more advantageously at least 80% by weight, more preferentially at least 85% by weight, in particular at least 90% by weight, more particularly at least 95% by weight and even more preferentially at least 97% by weight of iron relative to the total weight of the material M8; and less than 2% by weight of carbon, advantageously less than 1.5% by weight, preferably less than 1% by weight, preferentially less than 0.75% by weight, more preferentially less than 0.5% by weight, more particularly less than 0.2% by weight, and even more advantageously between 0.01% and 0.2% by weight of carbon relative to the total weight of the material M8; and less than 3% by weight of molybdenum, advantageously less than 2% by weight, preferentially less than 1.5% by weight, preferably less than 1.25% by weight, more preferentially less than 1% by weight, even more advantageously between 0.1% and 1% by weight of molybdenum relative to the total weight of the material M8; and/or less than 5% by weight of chromium, preferentially less than 4% by weight, advantageously less than 3% by weight, preferably less than 2% by weight, in particular between 0.5% and 2% by weight of chromium relative to the total weight of the material M8.

Preferably, the material M9 is the material M6 as defined above. More preferentially, the material M9 is chosen from polymers, in particular polyolefins (for instance polyethylene), and fluoropolymers, for instance PVDF (polyvinylidene fluoride), PTFE (polytetrafluoroethylene), PFAs (copolymers of C₂F₄ and of perfluorinated vinyl ether), FEPs (copolymers of tetrafluoroethylene and of perfluoropropene, for instance the copolymer of C₂F₄ and of C₃F₆), ETFE (copolymer of tetrafluoroethylene and of ethylene), and FKM (copolymer of hexafluoropropylene and of difluoroethylene); more preferentially, the material M9 is chosen from PTFEs and PFAs.

According to a preferred embodiment, the reactor used in step (c) of the process according to the invention comprises a base layer made of a material M8 coated with a surface layer made of a corrosion-resistant material M9, said material M8 comprising:
at least 60% by weight of iron, preferably at least 70% by weight of iron, advantageously at least 75% by weight, more even more advantageously at least 80% by weight, more preferentially at least 85% by weight, in particular at least 90% by weight, more particularly at least 95% by weight and even more preferentially at least 97% by weight of iron relative to the total weight of the material M8; and less than 2% by weight of carbon, advantageously less than 1.5% by weight, preferably less than 1% by weight, preferentially less than 0.75% by weight, more preferentially less than 0.5% by weight, more particularly less than 0.2% by weight, and even more advantageously between 0.01% and 0.2% by weight of carbon relative to the total weight of the material M8; and less than 3% by weight of molybdenum, advantageously less than 2% by weight, preferentially less than 1.5% by weight, preferably less than 1.25% by weight, more preferentially less than 1% by weight, even more advantageously between 0.1% and 1% by weight of molybdenum relative to the total weight of the material M8; and/or less than 5% by weight of chromium, preferentially less than 4% by weight, advantageously less than 3% by weight, preferably less than 2% by weight, in particular between 0.5% and 2% by weight of chromium relative to the total weight of the material M8; and
the material M9 being chosen from fluoropolymers, and in particular thermoplastic fluoropolymers, for instance PVDF (polyvinylidene fluoride), PTFE (polytetrafluoroethylene), PFAs (copolymers of C₂F₄ and of perfluorinated vinyl ether), FEPs (copolymers of tetrafluoroethylene and of perfluoropropene, for instance the copolymer of C₂F₄ and of C₃F₆), ETFE (copolymer of tetrafluoroethylene and of ethylene), and FKM (copolymer of hexafluoropropylene and of difluoroethylene), the material M9 more preferentially being chosen from PTFEs and PFAs.

According to another preferred embodiment, the reactor used in step (c) of the process according to the invention is made of a corrosion-resistant material M7, said material M7 comprising at least 60% by weight of iron, more particularly at least 70% by weight of iron relative to the total weight of the material M7; and less than 2% by weight of carbon, advantageously less than 1.5% by weight, preferably less than 1% by weight, more preferentially less than 0.75% by weight, in particular less than 0.5% by weight, more particularly less than 0.2% by weight, even more advantageously less than 0.1% by weight relative to the total weight of the material M7; and from 10% to 20% by weight of chromium, advantageously from 15% to 20% by weight, in particular from 16% to 18.5% by weight of chromium relative to the total weight of the material M7; and less than 15% by weight of nickel, preferentially between 10% and 14% by weight of nickel relative to the total weight of the material M7; and less than 3% by weight of molybdenum, advantageously between 2% and 3% by weight of molybdenum, relative to the total weight of the material M7; and less than 2.5% by weight of manganese, advantageously 2% by weight of manganese, relative to the total weight of the material M7; and less than 2% by weight of silicon, advantageously less than 1.5% by weight, preferably less than 1.25% by weight, more preferentially less than 1% by weight of silicon, relative to the total weight of the material M7.

Reactor

Preferably, the reactor of step (c) is fed with starting reagents via feed lines. The reactor may also comprise effluent or outlet lines for removing the reaction medium from the reactor.

Preferably, the feed or outlet lines of the reactor are made of a specific material that is also capable of withstanding corrosion, for example made of the abovementioned material M7. The feed lines may be of tubular shape. Alternatively, the feed or outlet lines may be made of a material comprising a base layer made of an abovementioned material M8 coated with a surface layer, which is liable to be in contact with the reaction medium, made of an abovementioned material M9.

According to one embodiment, the reactor of step (c) is a stirred reactor equipped with stirring head(s).

Among the stirring heads, examples that may be mentioned include turbomixers (for example Rushton straight-blade turbomixers or curved-blade turbomixers), helical strips, impellers (for example profiled-blade impellers), anchors, and combinations thereof.

The stirring head(s) may be attached to a central stirring shaft, and may be of identical or different nature. The stirring shaft may be driven by a motor, which is advantageously outside the reactor.

The design and size of the stirring heads may be chosen by a person skilled in the art as a function of the type of mixing to be performed (mixing of liquids, mixing of liquid and solid, mixing of liquid and gas, mixing of liquid, gas and solid) and of the desired mixing performance. In particular, the stirring head is chosen from the stirring heads that are the best suited for ensuring good homogeneity of the reaction medium. In the particular case of the presence of a medium which is at least a solid/liquid two-phase medium, or even a solid/liquid/gas three-phase medium, under the reaction conditions used in step (c), the stirring head is advantageously chosen from the stirring heads that are the best suited for ensuring good homogeneity of the reaction medium, and its stirring speed is advantageously adjusted to obtain good mixing of the medium in the event that the viscosity increases.

Preferably, the stirring head(s) are made of a corrosion-resistant material, for instance made of the material M7 as defined above, or may comprise a base layer made of an abovementioned material M8 coated with a surface layer, which is liable to be in contact with the reaction medium, made of an abovementioned corrosion-resistant material M9.

The reactor of step (c) may comprise cooling means.

The reactor of step (c) may be cooled by means of a jacket surrounding the reactor, in which a cooling fluid may circulate, for example water.

According to one embodiment, step (c) is performed in a reactor having a global thermal conductivity of greater than or equal to 10 W/m/° C., preferably greater than or equal to 15 W/m/° C.

When the reactor contains a base layer made of a material M8 coated with a surface layer made of a corrosion-resistant material M9, the global thermal conductivity λ8,9 of the reactor composed of M8 and M9 is calculated according to the following formula:

λ_{8,9}=(e₈+e₉)/((e₈/λ₈)+(e₉/λ₉))

with a thickness ea representing the thickness of the material M8, e₉ representing the thickness of the material M9, λ₈ representing the thermal conductivity of the material M8 and λ9 representing the thermal conductivity of the material M9.

When the reactor is made of a material M7, the global thermal conductivity is that of the material M7.

The neutralization reaction particularly involves compounds which may prove to be corrosive such as bis(fluorosulfonyl)imide F—(SO₂)—NH—(SO₂)—F and possibly residual HF.

The use of the reactor as defined above advantageously makes it possible to withstand the corrosiveness of the reaction medium (starting reagents and/or products formed) under the reaction conditions, and thus to avoid contamination of the medium with metal ions.

### Step (d)

The process according to the invention may also comprise an optional cation-exchange step (d), subsequent to step (c), comprising the reaction between the alkaline-earth metal salt of bis(fluorosulfonyl)imide and a lithium salt to obtain the lithium salt of bis(fluorosulfonyl)imide.

In particular, the process according to the invention comprises this step (d) when the salt obtained in step (c) is not the lithium salt of bis(fluorosulfonyl)imide.

Reaction Conditions

Step (d) is in particular a cation-exchange reaction for converting a compound of the abovementioned formula (I) F—(SO₂)—NM—(SO₂)—F (I), M being as described previously, into a lithium salt of bis(fluorosulfonyl)imide.

Preferably, the lithium salt is chosen from LiF, LiCl, L₁₂CO₃, LiOH, LiNO₃, LiBF₄ and mixtures thereof.

The lithium salt may be dissolved in a polar organic solvent chosen from the following families: alcohols, nitriles and carbonates. By way of example, mention may notably made of methanol, ethanol, acetonitrile, dimethyl carbonate and ethyl methyl carbonate.

The mole ratio of the compound of formula (I) relative to the lithium salt may vary: it may be at least equal to 1 and less than 5. Preferably, the mole ratio of compound of formula (I)/lithium salt is between 1.2 and 2.

The reaction medium may be left to stir for between 1 to 24 hours, and/or at a temperature of between, for example, 0° C. and 50° C.

At the end of the reaction, the reaction medium may be filtered and then optionally concentrated. The concentration step may optionally be performed with a thin-film evaporator, an atomizer, a rotary evaporator or any other device enabling solvent evaporation.

The filtration may be performed using a filter or a centrifugal separator.

The filter or the centrifugal separator is preferably made of a material M′ comprising:

at least 60% by weight of iron, more particularly at least 70% by weight of iron, relative to the total weight of the material M′;

less than 2% by weight of carbon, advantageously less than 1.5% by weight, preferably less than 1% by weight, more preferentially less than 0.75% by weight, in particular less than 0.5% by weight, more particularly less than 0.2% by weight, even more advantageously less than 0.1% by weight relative to the total weight of the material M′; and

from 10% to 20% by weight of chromium, advantageously from 15% to 20% by weight, in particular from 16% to 18.5% by weight of chromium relative to the total weight of the material M′;

and optionally:

less than 15% by weight of nickel, preferentially between 10% and 14% by weight of nickel, relative to the total weight of the material M′; and/or

less than 3% by weight of molybdenum, advantageously between 2% and 3% by weight of molybdenum, relative to the total weight of the material M′; and/or

less than 2.5% by weight of manganese, advantageously 2% by weight of manganese, relative to the total weight of the material M′; and/or

less than 2% by weight of silicon, advantageously less than 1.5% by weight, preferably less than 1.25% by weight, more preferentially less than 1% by weight of silicon relative to the total weight of the material M′. Preferably, the material M′ comprises at least 60% by weight of iron, more particularly at least 70% by weight of iron relative to the total weight of the material M′; and less than 2% by weight of carbon, advantageously less than 1.5% by weight, preferably less than 1% by weight, more preferentially less than 0.75% by weight, in particular less than 0.5% by weight, more particularly less than 0.2% by weight, even more advantageously less than 0.1% by weight relative to the total weight of the material M′; and from 10% to 20% by weight of chromium, advantageously from 15% to 20% by weight, in particular from 16% to 18.5% by weight of chromium relative to the total weight of the material M′; and less than 15% by weight of nickel, preferentially between 10% and 14% by weight of nickel relative to the total weight of the material M′; and less than 3% by weight of molybdenum, advantageously between 2% and 3% by weight of molybdenum, relative to the total weight of the material M′; and less than 2.5% by weight of manganese, advantageously 2% by weight of manganese, relative to the total weight of the material M′; and less than 2% by weight of silicon, advantageously less than 1.5% by weight, preferably less than 1.25% by weight, more preferentially less than 1% by weight of silicon, relative to the total weight of the material M′.

The filter or the centrifugal separator preferably comprises a base layer made of a material M1 coated with a surface layer made of a corrosion-resistant material M2, said material M1 comprising:
at least 60% by weight of iron, preferably at least 70% by weight of iron, advantageously at least 75% by weight, more even more advantageously at least 80% by weight, more preferentially at least 85% by weight, in particular at least 90% by weight, more particularly at least 95% by weight and even more preferentially at least 97% by weight of iron relative to the total weight of the material M1; and less than 2% by weight of carbon, advantageously less than 1.5% by weight, preferably less than 1% by weight, preferentially less than 0.75% by weight, more preferentially less than 0.5% by weight, more particularly less than 0.2% by weight, and even more advantageously between 0.01% and 0.2% by weight of carbon relative to the total weight of the material M1; and less than 3% by weight of molybdenum, advantageously less than 2% by weight, preferentially less than 1.5% by weight, preferably less than 1.25% by weight, more preferentially less than 1% by weight, even more advantageously between 0.1% and 1% by weight of molybdenum relative to the total weight of the material M1; and/or less than 5% by weight of chromium, preferentially less than 4% by weight, advantageously less than 3% by weight, preferably less than 2% by weight, in particular between 0.5% and 2% by weight of chromium relative to the total weight of the material M1; and
the material M2 being chosen from nickel-based alloys, in particular chosen from alloys comprising at least 40% by weight of nickel, advantageously at least 45% by weight, more preferentially at least 50% by weight, in particular at least 55% by weight, more particularly at least 60% by weight, favorably at least 65% by weight, even more favorably at least 70% by weight of nickel relative to the total weight of the material M2; and/or chromium in a content of less than 35% by weight relative to the total weight of the material M2, advantageously less than 30% by weight, preferably less than 20% by weight, more preferentially less than 15% by weight, in particular less than 10% by weight, more particularly less than 5% by weight relative to the total weight of the material M2; and/or molybdenum in a content of less than 35% by weight relative to the total weight of the material M2, advantageously less than 30% by weight, preferably less than 25% by weight, more preferentially less than 20% by weight, in particular less than 15% by weight, more particularly less than 10% by weight relative to the total weight of the material M2; and/or cobalt in a content of less than 10% by weight relative to the total weight of the material M2, advantageously less than 8% by weight, preferably less than 6% by weight, more preferentially less than 4% by weight, in particular less than 3% by weight, more particularly less than 2% by weight relative to the total weight of the material M2; and/or tungsten in a content of less than 5% by weight relative to the total weight of the material M2, advantageously less than 4% by weight, preferably less than 3% by weight, more preferentially less than 2% by weight, in particular less than 1% by weight relative to the total weight of the material M2; and/or iron in a content of less than 25% by weight relative to the total weight of the material M2, advantageously less than 20% by weight, preferably less than 15% by weight, more preferentially less than 10% by weight, in particular less than 7% by weight, more particularly less than 5% by weight relative to the total weight of the material M2; and/or manganese in a content of less than 5% by weight relative to the total weight of the alloy, advantageously less than 4% by weight, preferably less than 3% by weight, more preferentially less than 2% by weight, in particular less than 1% by weight, more particularly less than 0.5% by weight relative to the total weight of the material M2; and/or copper in a content of less than 50% by weight, advantageously less than 45% by weight, preferably less than 40% by weight, more preferentially less than 35% by weight, in particular less than 30% by weight, more particularly less than 25% by weight of copper relative to the total weight of the material M2; and/or less than 4% by weight of titanium relative to the total weight of the material M2, advantageously less than 3% by weight, preferably less than 2% by weight, more preferentially less than 1% by weight, in particular less than 0.5% by weight, more particularly less than 0.05% by weight relative to the total weight of the material M2, the material M2 favorably being free of titanium; and/or less than 6% by weight of niobium, advantageously less than 4% by weight, preferably less than 2% by weight, more preferentially less than 1% by weight, in particular less than 0.5% by weight, more particularly less than 0.05% by weight of niobium relative to the total weight of the material M2, the material M2 favorably being free of niobium.

Reactor

Step (d) may be performed in a reactor based on silicon carbide or based on a fluoropolymer or in a steel reactor comprising an inner surface, said inner surface liable to be in contact with the lithium salt of bis(fluorosulfonyl)imide being covered with a polymeric coating or with a silicon carbide coating.

The abovementioned fluoropolymer is advantageously chosen from PVDF (polyvinylidene fluoride), PTFE (polytetrafluoroethylene), PFAs (copolymers of C₂F₄ and of perfluorinated vinyl ether) and ETFE (copolymer of tetrafluoroethylene and of ethylene).

The fluoropolymer is advantageously chosen from PVDF, PFAs and ETFE.

The polymeric coating may be a coating comprising at least one of the following polymers: polyolefins, for instance polyethylene, fluoropolymers, for instance PVDF (polyvinylidene fluoride), PTFE (polytetrafluoroethylene), PFAs (copolymers of C₂F₄ and of perfluorinated vinyl ether), FEPs (copolymers of tetrafluoroethylene and of perfluoropropene, for instance the copolymer of C₂F₄ and of C₃F₆), ETFE (copolymer of tetrafluoroethylene and of ethylene), and FKM (copolymer of hexafluoropropylene and of difluoroethylene). Preferably, the polymeric coating comprises at least one fluoropolymer, and in particular PFA, PTFE or PVDF.

According to one embodiment, the reactor of step (d) is a stirred reactor equipped with stirring head(s).

Among the stirring heads, examples that may be mentioned include turbomixers (for example Rushton straight-blade turbomixers or curved-blade turbomixers), helical strips, impellers (for example profiled-blade impellers), anchors, and combinations thereof.

The stirring head(s) may be attached to a central stirring shaft, and may be of identical or different nature. The stirring shaft may be driven by a motor, which is advantageously outside the reactor.

The design and size of the stirring heads may be chosen by a person skilled in the art as a function of the type of mixing to be performed (mixing of liquids, mixing of liquid and solid, mixing of liquid and gas, mixing of liquid, gas and solid) and of the desired mixing performance. In particular, the stirring head is chosen from the stirring heads that are the best suited for ensuring good homogeneity of the reaction medium.

Preferably, the stirring head(s) are made of a steel material, preferably of carbon steel, comprising an outer surface, said outer surface liable to be in contact with the lithium salt of bis(fluorosulfonyl)imide being covered with a polymeric coating preferably as defined previously, or with a silicon carbide coating.

Step (e)

The process according to the invention may also comprise an optional step (e) of purification of the lithium salt of bis(fluorosulfonyl)imide.

Step (e) of purification of the lithium salt of bis(fluorosulfonyl)imide may be performed via any known conventional method. It may be, for example, an extraction method, a solvent-washing method, a reprecipitation method, a recrystallization method, or a combination thereof.

At the end of the abovementioned step (e) the lithium salt of bis(fluorosulfonyl)imide may be in the form of a solid, or of a composition comprising from 1% to 99.9% by weight of lithium salt of bis(fluorosulfonyl)imide.

According to a first embodiment, step (e) is a step of crystallizing LiFSl.

Preferably, during step (e), the LiFSl is crystallized under cold conditions, notably at a temperature of less than or equal to 25° C.

Preferably, during step (e), the crystallization of the LiFSl is performed in an organic solvent (crystallization solvent) chosen from chlorinated solvents, for instance dichloromethane, from alkanes, for instance pentane, hexane, cyclohexane and heptane, and from aromatic solvents, for instance toluene, in particular at a temperature of less than or equal to 25° C. Preferably, the LiFSl crystallized on conclusion of step (e) is recovered by filtration.

According to a second embodiment, step (e) comprises the following steps:
i′) optional dissolution of the LiFSl in an organic solvent OS1;
i) liquid-liquid extraction of the lithium salt of bis(fluorosulfonyl)imide with deionized water, and recovery of an aqueous solution of said lithium salt of bis(fluorosulfonyl)imide;
ii) optional concentration of said aqueous solution of said salt;
iii) liquid-liquid extraction of the lithium salt of bis(fluorosulfonyl)imide from said aqueous solution with at least one organic solvent OS2;
iv) concentration of the lithium salt of bis(fluorosulfonyl)imide by evaporation of said organic solvent OS2;

v) optional crystallization of the lithium salt of bis(fluorosulfonyl)imide.

Preferably, at least one of the steps i), ii), iii) or iv) is performed in:
equipment based on silicon carbide or based on a fluoropolymer; or
equipment made of steel, preferably of carbon steel, comprising an inner surface, said inner surface liable to be in contact with the lithium salt of bis(fluorosulfonyl)imide being covered with a polymeric coating or with a silicon carbide coating.

In the context of the invention, the terms “demineralized water” and “deionized water” are used equivalently.

The equipment may be a reactor, an evaporator, a mixer-decanter, a liquid-liquid extraction column, a decanter or an exchanger.

The equipment based on silicon carbide is preferably equipment made of bulk silicon carbide.

The equipment based on a fluoropolymer is preferably equipment made of bulk fluoropolymer.

The fluoropolymer is advantageously chosen from PVDF (polyvinylidene fluoride), PTFE (polytetrafluoroethylene), PFAs (copolymers of C₂F₄ and of perfluorinated vinyl ether) and ETFE (copolymer of tetrafluoroethylene and of ethylene).

The fluoropolymer of the equipment is advantageously chosen from PVDF, PFAs and ETFE.

The polymeric coating may be a coating comprising at least one of the following polymers: polyolefins, for instance polyethylene, fluoropolymers, for instance PVDF (polyvinylidene fluoride), PTFE (polytetrafluoroethylene), PFAs (copolymers of C₂F₄ and of perfluorinated vinyl ether), FEPs (copolymers of tetrafluoroethylene and of perfluoropropene, for instance the copolymer of C₂F₄ and of C₃F₆), ETFE (copolymer of tetrafluoroethylene and of ethylene), and FKM (copolymer of hexafluoropropylene and of difluoroethylene).

Preferably, the polymeric coating comprises at least one fluoropolymer, and in particular PFA, PTFE or PVDF.

Preferably:
step i) is performed in equipment as defined above, said equipment preferably being an extraction column or a mixer-decanter; and/or
step ii) is performed in equipment as defined above, said equipment preferably being an evaporator or an exchanger; and/or
step iii) is performed in equipment as defined above, said equipment preferably being an extraction column or a mixer-decanter; and/or
step iv) is performed in equipment as defined above, said equipment preferably being an evaporator or an exchanger.

It is possible for step (e) not to comprise the abovementioned step i′) if the LiFSl obtained in step (d) already comprises an organic solvent.

Step i) may be performed in equipment chosen from an extraction column, a mixer-decanter, and mixtures thereof.

According to one embodiment, the liquid-liquid extraction step i) is performed in:
an extraction column or a mixer-decanter, based on silicon carbide or based on a fluoropolymer preferably as defined previously; or
an extraction column or a mixer-decanter, made of steel, preferably made of carbon steel, said extraction column or said mixer-decanter comprising an inner surface, said inner surface liable to be in contact with the lithium salt of bis(fluorosulfonyl)imide being covered with a polymeric coating preferably as defined previously or with a silicon carbide coating.

Preferably, the liquid-liquid extraction step i) is performed in:
an extraction column or a mixer-decanter based on a fluoropolymer, for instance PVDF (polyvinylidene fluoride), or PFAs (copolymers of C₂F₄ and of perfluorinated vinyl ether); or
an extraction column or a mixer-decanter, made of steel, preferably made of carbon steel, said extraction column or said mixer-decanter comprising an inner surface, said inner surface liable to be in contact with the lithium salt of bis(fluorosulfonyl)imide being covered with a polymeric coating preferably as defined previously.

Mixer-decanters are well known to those skilled in the art. This equipment is typically a single machine comprising a mixing chamber and a decantation chamber, the mixing chamber comprising a stirring head advantageously enabling mixing of the two liquid phases. In the decantation chamber, the separation of the phases takes place by gravity.

The decantation chamber may be fed from the mixing chamber by overspill, from the bottom of the mixing chamber, or via a perforated wall between the mixing chamber and the decantation chamber.

The extraction column may comprise:
at least one packing, for instance random packing and/or structured packing. This packaging may be Raschig rings, Pall rings, Saddle rings, Berl saddles, Intalox saddles, or beads;
and/or
trays, for instance perforated trays, fixed valve trays, movable valve trays, bubble trays or combinations thereof;
and/or
devices for atomizing one phase in another, for instance nozzles; said packing(s), tray(s) or atomization device(s) preferably being made of a polymeric material, the polymeric material possibly comprising at least one polymer chosen from polyolefins, for instance polyethylene, fluoropolymers, for instance PVDF (polyvinylidene fluoride), PTFE (polytetrafluoroethylene), PFAs (copolymers of C₂F₄ and of perfluorinated vinyl ether), FEPs (copolymers of tetrafluoroethylene and of perfluoropropene, for instance the copolymer of C₂F₄ and of C₃F₆), ETFE (copolymer of tetrafluoroethylene and of ethylene), and FKM (copolymer of hexafluoropropylene and of difluoroethylene).

The extraction column may also comprise chicanes integrally fastened to the side walls of said column. The chicanes advantageously make it possible to limit the phenomenon of axial mixing.

In the context of the invention, the term “packing” refers to a solid structure that is capable of increasing the area of contact between the two liquids placed in contact.

The height and/or diameter of the extraction column typically depend(s) on the nature of the liquids to be separated.

The extraction column may be a static or stirred column. Preferably, the extraction column is stirred, preferentially mechanically. It comprises, for example, one or more stirring heads attached to an axial rotating shaft. Among the stirring heads, examples that may be mentioned include turbomixers (for example Rushton straight-blade turbomixers or curved-blade turbomixers), impellers (for example profiled-blade impellers), disks, and mixtures thereof. Stirring advantageously allows the formation of fine droplets to disperse one liquid phase in the other, and thus to increase the interfacial area of exchange. Preferably, the stirring speed is chosen so as to maximize the interfacial area of exchange.

Preferably, the stirring head(s) are made of a steel material, preferably of carbon steel, comprising an outer surface, said outer surface liable to be in contact with the lithium salt of bis(fluorosulfonyl)imide being covered with a polymeric coating preferably as defined previously, or with a silicon carbide coating.

According to the invention, the abovementioned step i) may be repeated at least once, preferably repeated from 1 to 10 times, preferentially from 1 to 4 times. When step i) is repeated, it may be performed in several mixer-decanters in series.

Step i) may be performed continuously or batchwise, preferably continuously.

According to one embodiment, step i) comprises the addition of deionized water to the solution of LiFSl in the abovementioned organic solvent OS1, for example obtained during previous synthetic steps, to allow the dissolution of said salt and the extraction of said salt into water (aqueous phase).

In the particular case of a batchwise step, and during the repetition of step i), an amount of deionized water corresponding to at least half of the mass of the initial solution may be added in a first extraction, followed by an amount greater than or equal to about a third of the mass of the initial solution during the second extraction, and then an amount greater than or equal to about a quarter of the mass of the initial solution during the third extraction.

In the event of multiple extractions (repetition of step i)), the extracted aqueous phases are pooled to form a single aqueous solution.

Step i) advantageously allows the production of an aqueous phase and an organic phase, which are separated. Step ii) is thus advantageously performed on the aqueous solution extracted in step a) (single aqueous phase or pooled aqueous phases in the case of repetition of step i)).

On conclusion of step i), an aqueous solution of LiFSl is advantageously obtained. Preferably, the mass content of LiFSl in the aqueous solution is between 5% and 35%, preferably between 10% and 25%, relative to the total mass of the solution.

Step (e) may comprise a concentration step ii) between step i) and step iii), preferably to obtain an aqueous solution of LiFSl comprising a mass content of LiFSl of between 20% and 80%, in particular between 25% and 80%, preferably between 25% and 70% and advantageously between 30% and 65% relative to the total mass of the solution.

The concentration step may be performed under reduced pressure, for example at a pressure below 50 mbar abs (preferably below 30 mbar abs), and/or at a temperature of between 25° C. and 60° C., preferably between 25° C. and 50° C., preferentially between 25° C. and 40° C.

Step ii) may be performed in at least one item of equipment chosen from an evaporator or an exchanger.

According to one embodiment, the concentration step ii) is performed in:
an evaporator or an exchanger, based on silicon carbide or based on a fluoropolymer preferably as defined previously; or
an exchanger or evaporator, made of steel, preferably made of carbon steel, said exchanger or evaporator comprising an inner surface, said inner surface liable to be in contact with the lithium salt of bis(fluorosulfonyl)imide being covered with a polymeric coating preferably as defined previously or with a silicon carbide coating. Preferably, step ii) is performed in:
an exchanger or evaporator, based on silicon carbide; or
an exchanger or evaporator, made of steel, preferably made of carbon steel, said exchanger or evaporator comprising an inner surface, said inner surface liable to be in contact with the lithium salt of bis(fluorosulfonyl)imide being covered with a silicon carbide coating.

Preferably, the purification step (e) according to the invention comprises step ii). After concentration ii) of the aqueous solution obtained on conclusion of step a), a concentrated aqueous solution of LiFSl is obtained.

Step iii) may be performed on the aqueous solution obtained on conclusion of step i) or of the concentration step ii) or of another optional intermediate step.

Step iii) may be performed in equipment chosen from an extraction column, a mixer-decanter, and mixtures thereof.

According to one embodiment, the liquid-liquid extraction step iii) is performed in:
an extraction column or a mixer-decanter, based on silicon carbide or based on a fluoropolymer preferably as defined previously; or
an extraction column or a mixer-decanter, made of steel, preferably made of carbon steel, said extraction column or said mixer-decanter comprising an inner surface, said inner surface liable to be in contact with the lithium salt of bis(fluorosulfonyl)imide being covered with a polymeric coating preferably as defined previously or with a silicon carbide coating.

Preferably, the liquid-liquid extraction step iii) is performed in:
an extraction column or a mixer-decanter based on a fluoropolymer, for instance PVDF (polyvinylidene fluoride), or PFAs (copolymers of C₂F₄ and of perfluorinated vinyl ether); or
an extraction column or a mixer-decanter, made of steel, preferably made of carbon steel, said extraction column or said mixer-decanter comprising an inner surface, said inner surface liable to be in contact with the lithium salt of bis(fluorosulfonyl)imide being covered with a polymeric coating preferably as defined previously.

The extraction column may be a static or stirred column. Preferably, the extraction column is stirred, preferentially mechanically. It comprises, for example, one or more stirring heads attached to an axial rotating shaft. Among the stirring heads, examples that may be mentioned include turbomixers (for example Rushton straight-blade turbomixers or curved-blade turbomixers), impellers (for example profiled-blade impellers), disks, and mixtures thereof. Stirring advantageously allows the formation of fine droplets to disperse one liquid phase in the other, and thus to increase the interfacial area of exchange. Preferably, the stirring speed is chosen so as to maximize the interfacial area of exchange.

Preferably, the stirring head(s) are made of a steel material, preferably of carbon steel, comprising an outer surface, said outer surface liable to be in contact with the lithium salt of bis(fluorosulfonyl)imide being covered with a polymeric coating preferably as defined previously, or with a silicon carbide coating.

Step iii) advantageously makes it possible to recover an organic phase, saturated with water, containing the LiFSl (it is a solution of LiFSl in the at least organic solvent OS2, said solution being saturated with water).

The solvent OS2 for extraction of the LiFSl salt dissolved in deionized water is advantageously:

a good solvent for the LiFSl salt, i.e. the LiFSl may have a solubility of greater than or equal to 10% by weight relative to the total weight of the sum of LiFSl plus solvent; and/or

sparingly soluble in water, i.e. it has a solubility of less than or equal to 1% by weight relative to the total weight of the sum of solvent plus water.

According to one embodiment, the organic solvent OS2 is chosen from the group constituted of esters, nitriles, ethers, chlorinated solvents and aromatic solvents, and mixtures thereof. Preferably, the solvent OS2 is chosen from ethers and esters, and mixtures thereof.

For example, mention may be made of diethyl carbonate, dimethyl carbonate, ethyl methyl carbonate, methyl t-butyl ether, cyclopentyl methyl ether, ethyl acetate, propyl acetate, methyl acetate, butyl acetate, methyl propionate, dichloromethane, tetrahydrofuran, diethyl ether, and mixtures thereof. Preferably, the solvent OS2 is chosen from methyl t-butyl ether, cyclopentyl methyl ether, ethyl acetate, propyl acetate and butyl acetate, and mixtures thereof, said organic solvent OS2 advantageously being butyl acetate.

According to the invention, step iii) may be repeated at least once, preferably repeated from 1 to 10 times, preferentially from 1 to 4 times. When step iii) is repeated, it may be performed in several mixer-decanters in series. In the event of multiple extractions (repetition of step iii)), the extracted organic phases are pooled to form a single organic solution.

Step iii) may be performed continuously or batchwise, preferably continuously.

According to one embodiment, step iii) comprises the addition of at least one organic solvent OS2 to the aqueous solution of LiFSl, to allow the dissolution of said salt, and the extraction of said salt into the organic phase.

In the particular case of a batchwise process, and during the repetition of step iii), the mass amount of organic solvent(s) OS2 used may range between 1/6 and 1 times the mass of the aqueous phase. Preferably, the organic solvent(s) S2/water mass ratio, during an extraction of step b), ranges from 1/6 to 1/1, the number of extractions ranging in particular from 2 to 10.

According to one embodiment, the mass content of LiFSl in solution in the organic phase obtained on conclusion of step iii) is between 5% and 35%, preferably between 10% and 25% by mass, relative to the total mass of the solution.

Step iv) may comprise:

a step iv-1) of preconcentration of the solution obtained in the preceding step; and

a step iv-2) of concentration of the solution obtained in step iv-1).

Step iv-1) advantageously makes it possible to obtain a solution of LiFSl in the at least organic solvent OS2 comprising a mass content of LiFSl of between 20% and 60% and preferably between 30% and 50% by mass relative to the total mass of the solution.

The preconcentration step iv-1) may be performed:
at a temperature ranging from 25° C. to 60° C., preferably from 25° C. to 50° C., and/or
under reduced pressure, for example at a pressure below 50 mbar abs, in particular at a pressure below 30 mbar abs.

Step iv-1) may be performed in equipment chosen from an evaporator or an exchanger.

According to one embodiment, the preconcentration step iv-1) is performed in:
an exchanger or an evaporator, based on silicon carbide or based on a fluoropolymer preferably as defined previously; or
an exchanger or an evaporator, made of steel, preferably made of carbon steel, said exchanger or evaporator comprising an inner surface, said inner surface liable to be in contact with the lithium salt of bis(fluorosulfonyl)imide being covered with a polymeric coating preferably as defined previously or with a silicon carbide coating.

Preferably, step iv-1) is performed in:
an exchanger or evaporator, based on silicon carbide; or
an exchanger or evaporator, made of steel, preferably made of carbon steel, said exchanger or evaporator comprising an inner surface, said inner surface liable to be in contact with the lithium salt of bis(fluorosulfonyl)imide being covered with a silicon carbide coating.

Step iv-2) may be performed in equipment chosen from an evaporator, for instance a thin-film evaporator (and preferentially a short-path thin-film evaporator), or an exchanger. Preferably, step iv-2) is performed in a short-path thin-film evaporator.

Step iv-2) may be performed in:
an evaporator or an exchanger, based on silicon carbide or based on a fluoropolymer preferably as defined previously; or
an exchanger or evaporator, made of steel, preferably made of carbon steel, said exchanger or evaporator comprising an inner surface, said inner surface liable to be in contact with the lithium salt of bis(fluorosulfonyl)imide being covered with a polymeric coating preferably as defined previously or with a silicon carbide coating.

According to a preferred embodiment, the abovementioned step (e) comprises a step iv-2) of concentration of the lithium salt of bis(fluorosulfonyl)imide by evaporation of said at least one organic solvent OS2, in a short-path thin-film evaporator, preferably under the following conditions:

temperature of between 30° C. and 100° C.;

pressure of between 10⁻³ mbar abs and 5 mbar abs;

residence time of less than or equal to 15 minutes.

According to one embodiment, the concentration step iv-2) is performed at a pressure of between 10⁻² mbar abs and 5 mbar abs, preferably between 5×10⁻² mbar abs and 2 mbar abs, preferentially between 5x10⁻¹ and 2 mbar abs, even more preferentially between 0.1 and 1 mbar abs and in particular between 0.1 and 0.6 mbar abs. According to one embodiment, step iv-2) is performed at a temperature of between 30° C. and 95° C., preferably between 40° C. and 90° C., preferentially between 40° C. and 85° C., and in particular between 50° C. and 80° C.

According to one embodiment, step iv-2) is performed with a residence time of less than or equal to 10 minutes, preferentially less than 5 minutes, preferably less than or equal to 3 minutes.

In the context of the invention, and unless otherwise mentioned, the term “residence time” means the time which elapses between the entry of the solution of lithium bis(fluorosulfonyl)imide salt (in particular obtained on conclusion of the abovementioned step b)) into the evaporator and the exit of the first drop of the solution.

According to a preferred embodiment, the temperature of the condenser of the thin-film short-path evaporator is between −55° C. and 10° C., preferably between −50° C. and 5° C., more preferentially between −45° C. and −10° C., and advantageously between −40° C. and −15° C.

The short-path thin-film evaporators according to the invention are also known as “wiped-film short-path” (WFSP) evaporators. They are typically referred to as such since the vapors generated during the evaporation cover a short path (travel a short distance) before being condensed in the condenser.

Among the short-path thin-film evaporators, mention may notably be made of the evaporators sold by the companies Buss SMS Ganzler ex Luwa AG, UIC GmbH or VTA Process.

Typically, the short-path thin-film evaporators may comprise a condenser for the solvent vapors placed inside the machine itself (in particular at the center of the machine), unlike other types of thin-film evaporator (which are not short-path evaporators) in which the condenser is outside the machine.

In this type of machine, the formation of a thin film, of product to be distilled, on the hot inner wall of the evaporator may typically be ensured by continuous spreading over the evaporation surface with the aid of mechanical means specified below.

The evaporator may notably be equipped, at its center, with an axial rotor on which are mounted the mechanical means that allow the formation of the film on the wall. They may be rotors equipped with fixed vanes, lobed rotors with three or four vanes made of flexible or rigid materials, distributed over the entire height of the rotor, or rotors equipped with mobile vanes, paddles, brushes, doctor blades or guided scrapers. In this case, the rotor may be constituted by a succession of pivot-articulated paddles mounted on a shaft or axle by means of radial supports. Other rotors may be equipped with mobile rollers mounted on secondary axles and said rollers are held tight against the wall by centrifugation. The spin speed of the rotor, which depends on the size of the machine, may be readily determined by a person skilled in the art.

According to one embodiment, the solution of LiFSl salt is introduced into the short-path thin-film evaporator with a flow rate of between 700 g/h and 1200 g/h, preferably between 900 g/h and 1100 g/h for an evaporation surface of 0.04 m².

According to the invention, on conclusion of the abovementioned step iv), the LiFSl may be obtained in solid form, and in particular in crystalline form, or in the form of a concentrated solution, the concentrated solution comprising less than 35% by weight of residual, preferably less than 30% by weight.

According to one embodiment, step (e) comprises a step v) of crystallization of the lithium salt of bis(fluorosulfonyl)imide obtained on conclusion of the abovementioned step iv).

Preferably, during step v), the LiFSl is crystallized under cold conditions, notably at a temperature of less than or equal to 25° C.

Preferably, step v) of crystallization of the LiFSl is performed in an organic solvent S3 (crystallization solvent) chosen from chlorinated solvents, for instance dichloromethane, from alkanes, for instance pentane, hexane, cyclohexane or heptane, and from aromatic solvents, for instance toluene, in particular at a temperature of less than or equal to 25° C. Preferably, the LiFSl crystallized on conclusion of step v) is recovered by filtration.

### Process

The process according to the invention advantageously leads to an LiFSl of high purity, and preferentially to an LiFSl of high purity having a reduced content of metal ions. The term “metal ions” in particular means ions derived from transition metals (for instance Cr, Mn, Fe, Ni, Cu), ions derived from post-transition metals (for instance Al, Zn and Pb), ions derived from alkali metals (for instance Na), ions derived from alkaline-earth metals (for instance Mg and Ca), and ions derived from silicon.

Thus, the process according to the invention advantageously leads to an LiFSl with a reduced content of ions derived from the following metals: Cr, Mn, Fe, Ni, Cu, Al, Zn, Mo, Co, Pb, Na, Si, Mg, Ca.

In particular, the process according to the invention advantageously leads to a composition comprising at least 99.9% by weight of LiFSl, preferably at least 99.95% by weight, preferentially at least 99.99% by weight of LiFSl, and said LiFSl optionally comprising at least one of the following impurities in the amounts indicated: 0≤H₂O≤100 ppm, 0≤Cl⁻≤100 ppm, 0≤SO₄²⁻≤100 ppm, 0≤F⁻200 ppm, 0≤FSO₃Li≤20 ppm, 0≤FSO₂NH₂≤20ppm, 0≤K≤100 ppm, 0≤Na≤10ppm, 0≤Si≤40ppm, 0≤Mg≤10 ppm, 0≤Fe≤10 ppm, 0≤Ca≤10 ppm, 0≤Pb≤10 ppm, 0≤Cu≤10 ppm, 0≤Cr≤10 ppm, 0≤Ni≤10 ppm, 0≤Al≤10 ppm, 0≤Zn≤10ppm,0≤Mn≤10 ppm, and/or0≤Co≤10 ppm.

In the context of the invention, the term “ppm” means ppm on a weight basis.

All the embodiments described above may be combined with each other. In particular, each embodiment of any step of the process of the invention may be combined with another particular embodiment.

In the context of the invention, the term “between x and y” or “ranging from x to y” means a range in which the limits x and y are included. For example, the temperature “between 30 and 100° C.” notably includes the values 30° C. and 100° C.

The present invention is illustrated by the example which follows, to which it is not, however, limited.

### EXPERIMENTAL SECTION

Two metal coupons of different constitution were subjected to chlorination operating conditions in order to determine their corrosion rate. The corrosion coupons were installed for 76 hours at 90° C. in a chlorination reactor.
Coupon A consists of a steel material coated with a layer of enamel.
Coupon B (comparative) consists of a 316L stainless steel material.

The corrosion rate of coupons A and B was determined after 76 hours, by microscopic observation. The data are collated in the table below:

| | | Coupon B |
|---|---|---|
| | Coupon A | (comparative) |
| Corrosion rate | Absence of corrosion | 116 μm/year |

Coupon A shows high stability over time, even under severe operating conditions. On the other hand, coupon B exhibits very significant corrosion, thus giving rise to a very high risk of contamination with metal ions.

1. A process for preparing a lithium salt of bis(fluorosulfonyl)imide F—(SO₂)—NLi—(SO₂)—F, comprising a step (a) comprising a step of chlorination of sulfamic acid HO—(SO₂)—NH₂ to obtain bis(chlorosulfonyl)imide Cl—(SO₂)—NH—(SO₂)—Cl, said step (a) being performed in a reactor made of a corrosion-resistant material M3, or in a reactor containing a base layer made of a material M1 coated with a surface layer made of a corrosion-resistant material M2.

2. The process as claimed in claim 1, in which the material M3 is pure nickel, comprising:
at least 99% of nickel relative to the total weight of said material M3; and
iron in a content of less than 1% by weight relative to the total weight of the material M3; and/or
manganese in a content of less than 1% by weight relative to the total weight of the material M3; and/or
silicon in a content of less than 1% by weight relative to the total weight of the material M3; and/or
copper in a content of less than 1% by weight relative to the total weight of the material M3; and/or
carbon in a content of less than 0.1% by weight relative to the total weight of the material M3;

3. The process as claimed in claim 1, in which the material M1 comprises:
i) at least 60% by weight of iron relative to the total weight of the material M1; and
ii) less than 2% by weight of carbon relative to the total weight of the material M1; and/or
less than 20% by weight of chromium relative to the total weight of the material M1; and/or
less than 15% by weight of nickel relative to the total weight of the material M1; and/or
less than 2% by weight of silicon relative to the total weight of the material M1; and/or
less than 2.5% by weight of manganese relative to the total weight of the material M1.

4. The process as claimed in claim 1, in which the material M1 comprises at least 60% by weight of iron relative to the total weight of the material M1; and less than 2% by weight of carbon relative to the total weight of the material M1; and less than 3% by weight of molybdenum relative to the total weight of the material M1; and/or less than 5% by weight of chromium relative to the total weight of the material M1.

5. The process as claimed in claim 1, in which the material M2 is chosen from the group consisting of enamel, fluoropolymers, and nickel-based alloys.

6. The process as claimed in claim 5, in which:
the fluoropolymers are chosen from PVDF (polyvinylidene fluoride), PTFE (polytetrafluoroethylene), PFAs (copolymers of C₂F₄ and of perfluorinated vinyl ether), FEPs (copolymers of tetrafluoroethylene and of perfluoropropene, and
the nickel-based alloys are chosen from alloys comprising at least 40% by weight of nickel relative to the total weight of the material M2; and/or chromium in a content of less than 35% by weight relative to the total weight of the material M2; and/or molybdenum in a content of less than 35% by weight relative to the total weight of the material M2 and/or cobalt in a content of less than 10% by weight relative to the total weight of the material M2; and/or tungsten in a content of less than 5% by weight relative to the total weight of the material M2, and/or iron in a content of less than 25% by weight relative to the total weight of the material M2; and/or manganese in a content of less than 5% by weight relative to the total weight of the alloy; and/or copper in a content of less than 50% by weight relative to the total weight of the material M2; and/or less than 4% by weight of titanium relative to the total weight of the material M2; and/or less than 6% by weight of niobium relative to the total weight of the material M2.

7. The process as claimed in claim 1, in which the reactor of step (a) is a stirred reactor equipped with stirring head(s), the stirring head(s) preferably being made of a corrosion-resistant material.

8. The process as claimed in claim 1, in which step (a) is performed with:
at least one sulfur-based acid, preferably chosen from the group consisting of chlorosulfonic acid (CISO₃H), sulfuric acid, oleum and mixtures thereof;
and at least one chlorinating agent chosen from the group consisting of thionyl chloride, oxalyl chloride, phosphorus pentachloride, phosphonyl trichloride, phosphoryl trichloride and mixtures thereof.

9. The process as claimed in claim 1, in which step (a) is performed with:
at a temperature of between 30° C. and 150° C.; and/or
with a reaction time of between 1 hour and 7 days; and/or
at a pressure of between 1 bar abs and 7 bar abs.

10. The process as claimed in claim 1, also comprising a step (b), subsequent to step (a), comprising the reaction of bis(chlorosulfonyl)imide Cl—(SO₂)—NH—(SO₂)—Cl with a fluorinating agent, to form bis(fluorosulfonate)imide F—(SO₂)—NH—(SO₂)—F.

11. The process as claimed in claim 10, in which the fluorinating agent is chosen from the group consisting of HF, KF, AsF₃, BiF₃, ZnF₂, SnF₂, PbF₂, CuF₂, and mixtures thereof.

12. The process as claimed in claim 10, in which step (b) is performed in a reactor made of a corrosion-resistant material M4, or in a reactor containing a base layer made of a material M5 coated with a surface layer made of a corrosion-resistant material M6.

13. The process as claimed in claim 12, comprising:
at least 60% by weight of iron relative to the total weight of the material M4;
less than 2% by weight of carbon relative to the total weight of the material M4; and
from 10% to 20% by weight of chromium, relative to the total weight of the material M4;
and optionally:
less than 15% by weight of nickel relative to the total weight of the material M4; and/or
less than 3% by weight of molybdenum relative to the total weight of the material M4; and/or
less than 2.5% by weight of manganese relative to the total weight of the material M4; and/or
less than 2% by weight of silicon relative to the total weight of the material M4.

14. The process as claimed in claim 12, in which the material M5 is the material M1 in which the material M1 comprises:
i) at least 60% by weight of iron relative to the total weight of the material M1; and
ii) less than 2% by weight of carbon relative to the total weight of the material M1; and/or
less than 3% by weight of molybdenum relative to the total weight of the material M1; and/or
less than 20% by weight of chromium relative to the total weight of the material M1; and/or
less than 15% by weight of nickel relative to the total weight of the material M1; and/or
less than 2% by weight of silicon relative to the total weight of the material M1; and/or
less than 2.5% by weight of manganese relative to the total weight of the material M1.

15. The process as claimed in claim 12, in which the material M6 is chosen from the group consisting of enamel, polymers, and nickel-based alloys.

16. The process as claimed in claim 10, also comprising a step (c), subsequent to step (b), comprising the preparation of an alkali metal or alkaline-earth metal salt of bis(fluorosulfonyl)imide by neutralization of bis(fluorosulfonyl)imide.

17. The process as claimed in claim 16, also comprising a cation-exchange step (d), subsequent to step (c), comprising the reaction between the alkaline-earth metal salt of bis(fluorosulfonyl)imide and a lithium salt, to obtain the lithium salt of bis(fluorosulfonyl)imide.

18. The process as claimed in claim 16, also comprising a step (e) of purification of the lithium salt of bis(fluorosulfonyl)imide.
